(19) United States
(12) Patent Application Publication
(10) Pub. No.: US 2012/0234687 A1
(43) Pub. Date: Sep. 20, 2012

(54) SOLDERING PROCESS USING ELECTRODEPOSITED INDIUM AND/OR GALLIUM, AND ARTICLE COMPRISING AN INTERMEDIATE LAYER WITH INDIUM AND/OR GALLIUM

(76) Inventors: Kenneth Seddon, Belfast (GB); Geetha Srinivasen, Belfast (GB); Anthony Wilson, Broadstone (GB)

(21) Appl. No.: 13/394,683

(22) PCT Filed: Sep. 8, 2010
(86) PCT No.: PCT/GB2010/051502

§ 371 Date: May 15, 2012

(30) Foreign Application Priority Data
Sep. 8, 2009 (GB) 0915669.6

(51) Int. Cl. B23K 35/26; C25D 3/54; C25D 3/56; C25D 5/02

(52) U.S. Cl. 205/114

(57) ABSTRACT

The present invention relates to a low temperature process for producing and joining metal substrates using an intermediate layer comprising indium or gallium, wherein the indium or gallium layer is formed by electrodeposition from an ionic liquid comprising an indium or gallium salt.

This invention relates to a novel process for producing and joining metal substrates. The invention preferably relates to a low temperature process for joining metal substrates using an intermediate layer comprising indium or gallium, wherein the indium or gallium layer is formed by electrodeposition from an ionic liquid comprising an indium or gallium salt. The invention further relates to articles produced by such processes.

One of the most widely used techniques for forming joints between metallic substrates, particularly in electronic applications, is soldering. The term soldering refers to a process in which two or more metal substrates are joined together by melting and flowing a filler metal having a relatively low melting point into the joint. Once the solder metal cools, the resulting joints are generally not as strong as the substrate metal, but have adequate strength, electrical conductivity and water-tightness for many applications.

A variety of filler metals are available for use in soldering processes. The filler metals, or solders, are usually in the form of alloys, and tin-based alloys are widely used. In particular, the eutectic alloy of 63% tin and 37% lead is often the alloy of choice due to its relatively low melting point (183° C.) and advantageous mechanical properties. However, lead-based materials are of concern due to their toxicity and are not recommended where they may come into contact with children, or where their use may result in leaching of the lead into groundwater. Although lead-free solders are known, these tend to have higher melting points than lead-containing solders and form less reliable joints.

One disadvantage of conventional soldering processes is that the heat required to melt the solder can be detrimental to the components that are being joined, particularly sensitive electronic components. This problem is obviously increased with lead-free solders having higher melting points. Low temperature soldering solutions are therefore of interest when forming solder interconnections in areas such as electronic packaging, and for the surface mounting of microelectronic devices in the manufacture of electronic circuits. Particularly preferred low temperature solders would have longer fatigue life, better mechanical properties, and higher thermal/electrical conductivity than conventional solders.

Another disadvantage of conventional soldering processes is that the metal(s) forming the solder or the metal substrates become susceptible to oxidation in air at the temperatures used to melt the solder, and the oxidised metals do not form effective joints. Accordingly it is customary to use a material known as flux to prevent oxidation of the substrates.

Flux is a substance which is nearly inert at room temperature, but which becomes strongly reducing at soldering temperatures, preventing the formation of oxides. However, the performance of different fluxes is variable, and the choice of flux needs to be carefully tailored according to the particular soldering application. In addition, many fluxes leave residues which need to be removed after the soldering operation and this often requires the use of volatile organic solvents. There is accordingly a need in the art for effective soldering processes which avoid the use of flux entirely. In particular, a preferred soldering process could be conducted at temperatures which are sufficiently low to substantially avoid metal oxidation.

A number of approaches have been proposed to form soldered joints without the use of flux, including solid-liquid interdiffusion bonding techniques and vapour deposition processes. However, these have not been straightforward due to the ongoing need to prevent oxidation of the solder metals.

Lee et al. (IEEE Trans. Comp. Hybrids, Manufact. Technol., vol. 14, 1991, 407-412) have proposed a fluxless soldering process wherein chromium, gold, tin and gold are successively deposited on a device die to form a multilayer composite. Oxidation of the tin layer is reduced as it is coated with a protective gold layer in the same vacuum deposition cycle. Chromium and gold layers are also deposited onto the surface of the substrate accepting the die. The die and the substrate are brought together and heated to 310-320° C., causing the tin layer to melt and dissolve the gold layers on the die and the substrate to form a near eutectic bond.

Lee et al. (IEEE Trans. Comp. Hybrids, Manufact. Technol., vol. 16, 1993, 789-793) have also developed a process which uses a lead-indium-gold multilayer composite, which is deposited on Ga/As wafers under high vacuum to inhibit oxidation. The gold layer further inhibits oxidation of indium by atmospheric oxygen. Using this composite solder, the Ga/As wafers may be bonded to alumina substrates at temperatures of 250° C. to form high quality joints that are resistant to thermal shock and shear.

Similar vacuum deposition processes using indium-copper multilayer composites and indium-silver multilayer composites have also been developed by Lee et at (Thin Solid Films, vol. 238, 1996, 243-246; and IEEE Trans. Comp., Packag. Manufact. Technol. A, vol. 20, 1996, 46-51). Bonding temperatures of 200° C. and 180° C. respectively are said to be necessary.

It has now been discovered that soldered joints having improved fatigue life and mechanical properties may be formed using electrochemical processes.

Electrochemical deposition is known in the art as a method of forming layers of metals on conductive substrates. In particular, the electrochemical deposition of metals using aqueous electrolyte baths is well-established. However, the use of aqueous electrolytes in such processes also has a number of disadvantages, which include a narrow electrochemical window, a limited operating temperature range, and problems associated with reduction of hydrogen ions when protic solvents are used.

Ionic liquids are a class of compounds which have been developed over the last few decades and which are finding increasing application in a wide range of industrial processes as alternatives to conventional solvents. The term “ionic liquid” as used herein refers to a liquid that can be produced by melting a salt, and when so produced consists solely of ions. An ionic liquid may be formed from a homogeneous substance comprising one species of cation and one species of anion, or it can be composed of more than one species of cation and/or more than one species of anion. Thus, an ionic liquid may be composed of more than one species of cation and one species of anion. An ionic liquid may further be composed of one species of cation, and one or more species of anion. Still further, an ionic liquid may be composed of more than one species of cation and more than one species of anion.

The term “ionic liquid” includes compounds having both high melting points and compounds having low melting points, e.g. at or below room temperature. Thus, many ionic liquids have melting points below 200° C., preferably below 150° C., particularly below 100° C., around room temperature (15 to 30° C.), or even below 0° C. Ionic liquids having melting points below around 30° C. are commonly referred to as “room temperature ionic liquids” and are often derived from organic salts having nitrogen-containing heterocyclic cations, such as imidazolium and pyridinium-based cations. In room temperature ionic liquids, the structures of the cation and anion prevent the formation of an ordered crystalline structure and therefore the salt is liquid at room temperature.

Ionic liquids are most widely used as solvents, because of their favourable properties, which include negligible vapour pressure, temperature stability, low flammability and recyclability. Due to the vast number of anion/cation combinations that are available it is possible to fine-tune the physical properties of the ionic liquid (e.g. melting point, density, viscosity, and miscibility with water or organic solvents) to suit the requirements of a particular application. In addition, ionic liquids are particularly suitable for use in electrochemical applications as they have good electrical conductivity, and wide electrochemical windows.

In accordance with a first aspect of the present invention there is provided a soldering process comprising the steps of:
a) providing at least two substrates, wherein each substrate has a first surface comprising a transition metal, aluminium, thallium, tin, lead, or bismuth, or an alloy thereof;
b) depositing a layer of a solder metal onto the first surface of at least one of the substrates by electrolysis of an electrodeposition mixture comprising an ionic liquid and a salt of the solder metal;
c) contacting the deposited layer of the solder metal with the first surface of the at least one other substrate or with a layer of the solder metal deposited thereon at a temperature of 160° C. or less so as to fuse the substrates;
wherein the deposited layer of the solder metal comprises indium, gallium, or a mixture thereof.

In preferred embodiments, the deposited layer of the solder metal comprises at least 25 mol % indium and/or gallium, more preferably at least 60 mol % indium and/or gallium, still more preferably at least 70 mol % indium and/or gallium, still more preferably at least 80 mol % indium and/or gallium, and most preferably at least 90 mol % indium and/or gallium. In further embodiments, the deposited layer of the solder metal comprises at least 95 mol % of indium and/or gallium, for example, at least 98 mol %, at least 99 mol % or 100 mol % indium and/or gallium.

In one embodiment, the ionic liquid has the formula:

[Cat⁺][X⁻];
wherein:
   [Cat⁺] represents one or more cationic species; and
   [X⁻] represents one or more anionic species.

In accordance with the present invention, [Cat⁺] may comprise a cationic species selected from: ammonium, azaannulenium, azathiazolium, benzimidazolium, benzofuranium, benzotriazolium, borolium, cinnolinium, diazabicyclodecenium, diazabicyclononenium, diazabicyclo-undecenium, dithiazolium, furanium, guanidinium, imidazolium, indazolium, indolinium, indolium, morpholinium, oxaborolium, oxaphospholium, oxazinium, oxazolium, iso-oxazolium, oxathiazolium, pentazolium, phospholium, phosphonium, phthalazinium, piperazinium, piperidinium, pyranium, pyrazinium, pyrazolium, pyridazinium, pyridinium, pyrimidinium, pyrrolidinium, pyrrolium, quinazolinium, quinolinium, iso-quinolinium, quinoxalinium, selenozolium, sulfonium, tetrazolium, iso-thiadiazolium, thiazinium, thiazolium, thiophenium, thiuronium, triazadecenium, triazinium, triazolium, iso-triazolium, and uranium.

In one embodiment, [Cat⁺] may comprise a quaternary nitrogen-containing heterocyclic cation selected from:

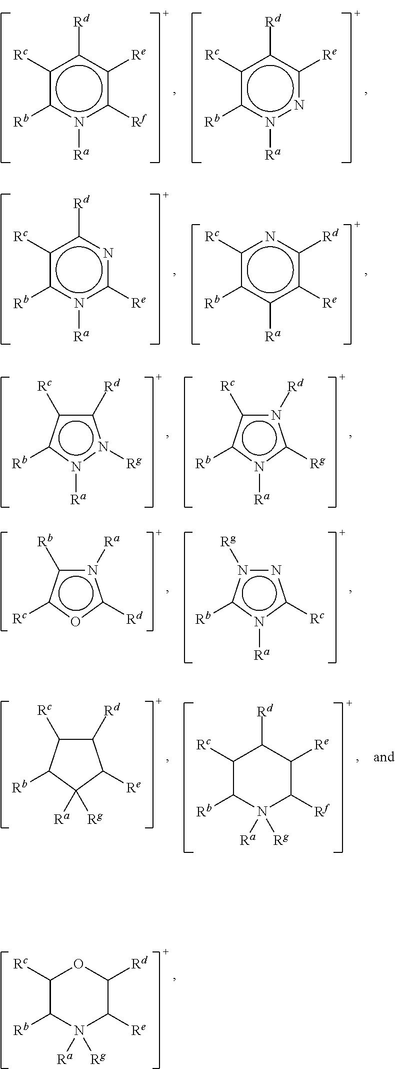

wherein: R^{a}, R^{b}, R^{c}, R^{d}, R^{e}, R^{f} and R^{g} are each independently selected from hydrogen, a C₁ to C₃₀, straight chain or branched alkyl group, a C₃ to C₈ cycloalkyl group, or a C₆ to C₁₀ aryl group, or any two of R^{b}, R^{c}, R^{d}, R^{e} and R^{f} attached to adjacent carbon atoms form a methylene chain —(CH₂)_{q}— wherein q is from 3 to 6; and wherein said alkyl, cycloalkyl or aryl groups or said methylene chain are unsubstituted or may be substituted by one to three groups selected from: C₁ to C₆ alkoxy, C₂ to C₁₂ alkoxyalkoxy, C₃ to C₆ cycloalkyl, C₆ to C₁₀ aryl, C₇ to C₁₀ alkaryl, C₇ to C₁₀ aralkyl, —CN, —OH, —SH, —NO₂, —CO₂R^{x}, —OC(O)R^{x}, —C(O)R^{x}, —C(S)R^{x}, —CS₂R^{x}, —SC(S)R^{x}, —S(O)(C₁ to C₆)alkyl, —S(O)O(C₁ to C₆)alkyl, —OS(O)(C₁ to C₆)alkyl, —S(C₁ to C₆)alkyl, —S—S(C₁ to C₆ alkyl), —NR^{x}C(O)NR^{y}R^{z}, —NR^{x}C(O)OR^{y}, —OC(O)NR^{y}R^{z}, —NR^{x}C(S)OR^{y}, —OC(S)NR^{y}R^{z}, —NR^{x}C(S)SR^{y}, —SC(S)NR^{y}R^{z}, —NR^{x}C(S)NR^{y}R^{z}, —C(O)NR^{y}R^{z}, —C(S)NR^{y}R^{z}, —NR^{y}R^{z}, or a heterocyclic group, wherein R^{x}, R^{y} and R^{z} are independently selected from hydrogen or C₁ to C₆ alkyl.

More preferably, R^{a}, R^{b}, R^{c}, R^{d}, R^{e}, R^{f} and R^{g} are each independently selected from hydrogen, a C₁ to C₃₀, straight chain or branched alkyl group, a C₃ to C₈cycloalkyl group, or a C₆ to C₁₀ aryl group, or any two of R^{b}, R^{c}, R^{d}, R^{e} and R^{f} attached to adjacent carbon atoms form a methylene chain —(CH₂)_{q}— wherein q is from 3 to 6, wherein said alkyl, cycloalkyl or aryl groups or said methylene chain are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, C₇ to C₁₀ alkaryl, —CN, —OH, —SH, —NO₂, —CO₂(C₁ to C₆)alkyl, and —OC(O)(C₁ to C₆)alkyl.

Still more preferably, R^{a}, R^{b}, R^{c}, R^{d}, R^{e}, R^{f} and R^{g} are each independently selected from hydrogen, C₁ to C₂₀ straight chain or branched alkyl group, a C₃ to C₆ cycloalkyl group, or a C₆ aryl group, wherein said alkyl, cycloalkyl or aryl groups are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, —CN, —OH, —SH, —NO₂, —CO₂(C₁ to C₆)alkyl, —OC(O)(C₁ to C₆)alkyl, C₆ to C₁₀ aryl and C₇ to C₁₀ alkaryl.

R^{a} is preferably selected from C₁ to C₃₀, linear or branched, alkyl, more preferably C₂ to C₂₀ linear or branched alkyl, still more preferably, C₁ to C₁₀ linear or branched alkyl, and most preferably C₁ to C₅ linear or branched alkyl.

Further examples include wherein R^{a} is selected from methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl and n-octadecyl.

In the cations comprising an R^{g} group, R^{g} is preferably selected from C₁ to C₁₀ linear or branched alkyl, more preferably, C₁ to C₅ linear or branched alkyl, and most preferably R^{g} is a methyl group.

In the cations comprising both an R^{a} and an R^{g} group, R^{a} and R^{g} are each preferably independently selected from C₁ to C₃₀, linear or branched, alkyl, and one of R^{a} and R^{g} may also be hydrogen. More preferably, one of R^{a} and R^{g} may be selected from C₁ to C₁₀ linear or branched alkyl, still more preferably, C₁ to C₈ linear or branched alkyl, and most preferably C₂ to C₈ linear or branched alkyl, and the other one of R^{a} and R^{g} may be selected from C₁ to C₁₀ linear or branched alkyl, more preferably, C₁ to C₅ linear or branched alkyl, and most preferably a methyl group.

In a further preferred embodiment, R^{a} and R^{g} may each be independently selected, where present, from C₁ to C₃₀ linear or branched alkyl and C₁ to C₁₅ alkoxyalkyl.

Preferably, R^{b}, R^{c}, R^{d}, R^{e}, and R^{f} are independently selected from hydrogen and C₁ to C₅ linear or branched alkyl, and most preferably R^{b}, R^{c}, R^{d}, R^{e}, and R^{f} are hydrogen.

In accordance with this embodiment of the invention, [Cat⁺] preferably comprises a cationic species selected from:

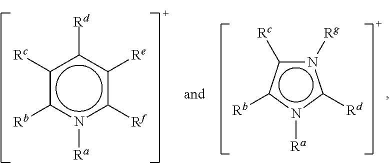

wherein: R^{a}, R^{b}, R^{c}, R^{d}, R^{e}, R^{f}, and R^{g} are as defined above.

More preferably, [Cat⁺] comprises a cationic species selected from:

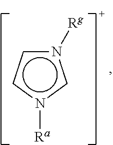

wherein: R^{a} and R^{g} are as defined above.

For example, [Cat⁺] may comprise a cationic species selected from methylimidazolium, 1,3-dimethylimidazolium, 1-ethyl-3-methylimidazolium, 1-butyl-3-methylimidazolium, 1-hexyl-3-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium, and 1-octadecyl-3-methylimidazolium.

In a further embodiment of the invention, [Cat⁺] may comprise an acyclic cationic species selected from:

[N(R^{a})(R^{b})(R^{c})(R^{d})]⁺, [P(R^{a})(R^{b})(R^{c})(R^{d})]⁺, and [S(R^{a})(R^{b})(R^{c})]⁺,
wherein: R^{a}, R^{b}, R^{c}, and R^{d} are each independently selected from a C₁ to C₃₀, straight chain or branched alkyl group, a C₃ to C₈ cycloalkyl group, or a C₆ to C₁₀ aryl group, or any two of R^{b}, R^{c}, R^{d}, R^{e} and R^{f} attached to adjacent carbon atoms form a methylene chain —(CH₂)_{q}— wherein q is from 3 to 6; and wherein said alkyl, cycloalkyl or aryl groups or said methylene chain are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, C₇ to C₁₀ alkaryl, C₇ to C₁₀ aralkyl, —CN, —OH, —SH, —NO₂, —CO₂R^{x}, —CO(O)R^{x}, —C(O)R^{x}, —C(S)R^{x}, —CS₂R^{x}, —SC(S)R^{x}, —S(O)(C₁ to C₆)alkyl, —S(O)O(C₁ to C₆)alkyl, —OS(O)(C₁ to C₆)alkyl, —S(C₁ to C₆)alkyl, —S—S(C₁ to C₆ alkyl), —NR^{x}C(O)NR^{y}R^{z}, —NR^{x}C(O)OR^{y}, —OC(O)NR^{y}R^{z}, —NR^{x}C(S)OR^{y}, —OC(S)NR^{y}R^{z}, —NR^{x}C(S)SR^{y}, —SC(S)NR^{y}R^{z}, —NR^{x}C(S)NR^{y}R^{z}, —C(O)NR^{y}R^{z}, —C(S)NR^{y}R^{z}, —NR^{y}R^{z}, or a heterocyclic group, wherein R^{x}, R^{y} and R^{z} are independently selected from hydrogen or C₁ to C₆ alkyl, and wherein one of R^{a}, R^{b}, R^{c}, and R^{d} may also be hydrogen.

More preferably, [Cat⁺] is selected from:

[N(R^{a})(R^{b})(R^{c})(R^{d})]⁺ and [P(R^{a})(R^{b})(R^{c})(R^{d})]⁺,
wherein: R^{a}, R^{b}, R^{c}, and R^{d} are each independently selected from a C₁ to C₁₅ straight chain or branched alkyl group, a C₃ to C₆ cycloalkyl group, or a C₆ aryl group, wherein said alkyl, cycloalkyl or aryl groups are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, —CN, —OH, —SH, —NO₂, —CO₂(C₁ to C₆)alkyl, —OC(O)(C₁ to C₆)alkyl, C₆ to C₁₀ aryl and C₇ to C₁₀ alkaryl, and wherein one of R^{a}, R^{b}, R^{c}, and R^{d} may also be hydrogen.

Further examples include wherein R^{a}, R^{b}, R^{c} and R^{d} are independently selected from methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl and n-octadecyl. More preferably two or more, and most preferably three or more, of R^{a}, R^{b}, R^{c} and R^{d} are independently selected from methyl, ethyl, propyl and butyl.

Still more preferably, R^{b}, R^{c}, and R^{d} are each the same alkyl group selected from methyl, ethyl n-butyl, and n-octyl, and R^{a} is selected from hydrogen, methyl, n-butyl, n-octyl, n-tetradecyl, 2-hydroxyethyl, or 4-hydroxy-n-butyl.

For example [Cat⁺] may comprise a cationic species selected from: tetramethylammonium, tetraethylammonium, tetrapropylammonium, tetrabutylammonium, tetrapentylammonium, tetrahexylammonium, 2-hydroxyethyl-trimethylammonium, 2-[(C₁-C₆)alkoxy]ethyl-trimethylammonium, tetraethylphosphonium, tetrapropylphosphonium, tetrabutylphosphonium, tetrapentylphosphonium, tetrahexylphosphonium and trihexyltetradecylphosphonium.

In a preferred embodiment, [Cat⁺] may comprise a cationic species having the formula:

[Cat⁺-(Z-Bas)ₙ]
wherein:
   Cat⁺ is a cationic moiety;
   Bas is a basic moiety;
   Z is a covalent bond joining Cat⁺ and Bas, or 1, 2 or 3 aliphatic divalent linking groups each containing 1 to 10 carbon atoms and each optionally containing 1, 2 or 3 oxygen atoms;
   n is an integer of from 1 to 3, and is preferably 1.

Suitably, Bas comprises at least one basic nitrogen, phosphorus, sulphur, or oxygen atom. More preferably, Bas comprises at least one basic nitrogen atom.

Preferably, Bas is selected from —N(R¹)(R²), —P(R¹)(R²) and —SR³. Bas may also be —OR³. Suitably, R¹ and R² are independently selected from hydrogen, linear or branched alkyl, cycloalkyl, aryl and substituted aryl, or, in the case of a —N(R¹)(R²) group, R¹ and R² together with the interjacent nitrogen atom form part of a heterocyclic ring. Suitably, R³ is selected from linear or branched alkyl, cycloalkyl, aryl and substituted aryl.

Preferably, R¹, R² and R³ are selected from methyl, ethyl, n-propyl, isopropyl, n-butyl, iso-butyl, tert-butyl, n-pentyl, n-hexyl, cyclohexyl, benzyl and phenyl, or, in the case of a —N(R¹)(R²) group, R¹ and R² together represent a tetramethylene or pentamethylene group optionally substituted by one or more C₁₋₄ alkyl groups.

Preferably, the basic moiety is a “hindered basic group” i.e. is a functional group that acts as a base and, owing to steric hindrance, does not chemically bond to any of the components of the oil (other of course than by accepting a proton in the usual reaction of a Brønsted acid with a Brønsted base). Suitable hindered basic groups include —N(CH(CH₃)₂)₂ and —N(C(CH₃)₃)₂. Preferably, the hindered basic group has a lower nucleophilicity (or greater steric hindrance) than —N(C₂H₅)₃.

In the context of the present invention, the group —OH is not considered basic due to difficulties with protonation. Accordingly, Bas as defined herein does not include —OH, and in a preferred embodiment, does not include —OR³.

Z may be a divalent organic radical having from 1 to 18 carbon atoms, preferably 1 to 8 carbon atoms, more preferably, 2 to 6 carbon atoms. The divalent organic radical, Z, may be branched or unbranched. The divalent organic radical, Z, may be substituted or unsubstituted. Preferably, the valence bonds are on different carbon atoms of the divalent organic radical, Z.

Suitably, the divalent organic radical, Z, is a divalent aliphatic radical (for example, alkylene, alkenylene, cycloalkylene, oxyalkylene, oxyalkyleneoxy, alkyleneoxyalkylene or a polyoxyalkylene) or is a divalent aromatic radical (for example, arylene, alkylenearylene or alkylenearylenealkylene).

Preferably, Z is:
(a) a divalent alkylene radical selected from: —(CH₂—CH₂)—, (CH₂—CH₂—CH₂)—, —(CH₂—CH₂—CH₂—CH₂)—, —(CH₂—CH₂—CH₂—CH₂—CH₂)—, —(CH₂—CH₂—CH₂—CH₂—CH₂—CH₂)—, —(CH₂—CH(CH₃))—, and —(CH₂—CH(CH₃)—CH₂—CH(CH₃))—;
(b) a divalent alkyleneoxyalkylene radical selected from: —(CH₂—CH₂—O—CH₂—CH₂)—, —(CH₂—CH₂—O—CH₂—CH₂—CH₂)—, and —(CH₂—CH(CH₃)—O—CH₂—CH(CH₃))—;
(c) a divalent polyoxyethylene radical selected from: —(CH₂CH₂O)ₙ— where n is an integer in the range 1 to 9 or —(CH₂CH(CH₃)O)ₘ— where m is an integer in the range 1 to 6; and
(d) a divalent alkylenearylene or an alkylenearylenealkylene radical selected from: —(CH₂—C₆H₄)—, and —(CH₂—C₆H₄—CH₂)—.

The Cat⁺ moiety in [Cat⁺-Z-Bas] may be a heterocyclic ring structure selected from: ammonium, azaannulenium, azathiazolium, benzimidazolium, benzofuranium, benzothiophenium, benzotriazolium, borolium, cinnolinium, diazabicyclodecenium, diazabicyclononenium, diazabicycloundecenium, dibenzofuranium, dibenzothiophenium, dithiazolium, furanium, guanidinium, imidazolium, indazolium, indolinium, indolium, morpholinium, oxaborolium, oxaphospholium, oxathiazolium, oxazinium, oxazolium, iso-oxazolium, oxazolinium, pentazolium, phospholium, phosphonium, phthalazinium, piperazinium, piperidinium, pyranium, pyrazinium, pyrazolium, pyridazinium, pyridinium, pyrimidinium, pyrrolidinium, pyrrolium, quinazolinium, quinolinium, iso-quinolinium, quinoxalinium, selenazolium, sulfonium, tetrazolium, thiadiazolium, iso-thiadiazolium, thiazinium, thiazolium, iso-thiazolium, thiophenium, thiuronium, triazadecenium, triazinium, triazolium, iso-triazolium, and uranium.

Examples of [Cat⁺-Z-Bas] where Cat⁺ is a heterocyclic ring structure include:

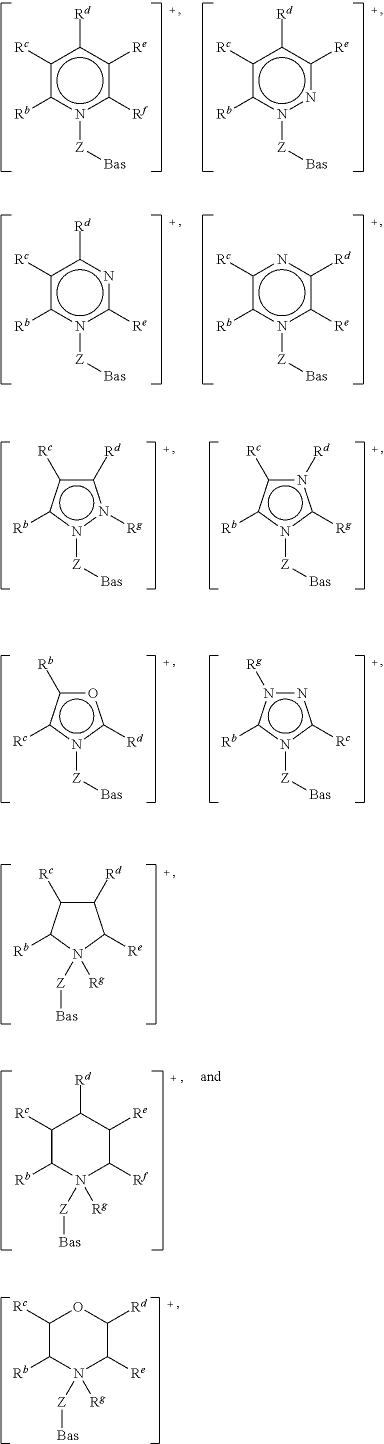

wherein: R^{b}, R^{c}, R^{d}, R^{e}, R^{f}, R^{g}, Bas and Z are as defined above.

Preferred [Cat⁺-Z-Bas], where Cat⁺ is a heterocyclic ring structure, include:

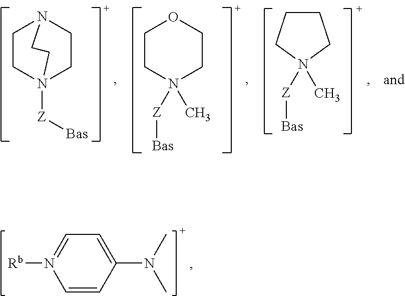

wherein: Bas, Z and R^{b} are as defined above.

Still more preferably, Cat⁺ is a heterocyclic ring structure and Bas is a sterically hindered amino group, for example:

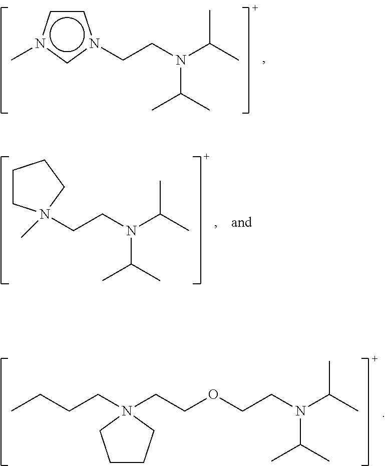

The Cat⁺ moiety in [Cat⁺-Z-Bas] may also be an acyclic cationic moiety. Preferably, the acyclic cationic moiety comprises a group selected from amino, amidino, imino, guanidino, phosphino, arsino, stibino, alkoxyalkyl, alkylthio, alkylseleno and phosphinimino.

Where the Cat⁺ moiety is an acyclic cationic moiety, [Cat⁺-Z-Bas] is preferably selected from:

[N(Z-Bas)(R^{b})(R^{c})(R^{d})]⁺ and [P(Z-Bas)(R^{b}(R^{c})(R^{d})]⁺
wherein: Bas, Z, R^{b}, R^{c}, and R^{d} are as defined above.

Examples of preferred [Cat⁺-Z-Bas] of this class include:

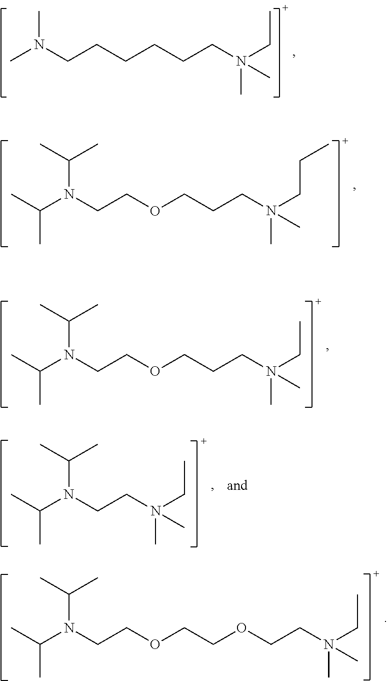

where Bas is the sterically hindered amino group, —N(CH(CH₃)₂)₂.

[Cat⁺-Z-Bas] may also be:

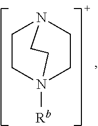

wherein: R^{b} is as defined above.

In a further preferred embodiment, [Cat⁺] may comprise a cationic species having the formula:

[Cat⁺-(Z-Acid)ₙ]
wherein:
   Cat⁺ is a cationic moiety;
   Acid is a basic moiety;
   Z is as defined above; and
   n is an integer of from 1 to 3, and is preferably 1.

Acid is preferably selected from is selected from —SO₃H, —CO₂H, —PO(R)(OH)₂ and —PO(R)₂(OH); wherein each R is, for example, independently C₁ to C₆ alkyl.

The Cat⁺ moiety in [Cat⁺-Z-Acid] may be a heterocyclic ring structure selected from: ammonium, azaannulenium, azathiazolium, benzimidazolium, benzofuranium, benzothiophenium, benzotriazolium, borolium, cinnolinium, diazabicyclodecenium, diazabicyclononenium, diazabicycloundecenium, dibenzofuranium, dibenzothiophenium, dithiazolium, furanium, guanidinium, imidazolium, indazolium, indolinium, indolium, morpholinium, oxaborolium, oxaphospholium, oxathiazolium, oxazinium, oxazolium, iso-oxazolium, oxazolinium, pentazolium, phospholium, phosphonium, phthalazinium, piperazinium, piperidinium, pyranium, pyrazinium, pyrazolium, pyridazinium, pyridinium, pyrimidinium, pyrrolidinium, pyrrolium, quinazolinium, quinolinium, iso-quinolinium, quinoxalinium, selenazolium, sulfonium, tetrazolium, thiadiazolium, iso-thiadiazolium, thiazinium, thiazolium, iso-thiazolium, thiophenium, thiuronium, triazadecenium, triazinium, triazolium, iso-triazolium, and uronium.

Examples of [Cat⁺-Z-Acid] where Cat⁺ is a heterocyclic ring structure include:

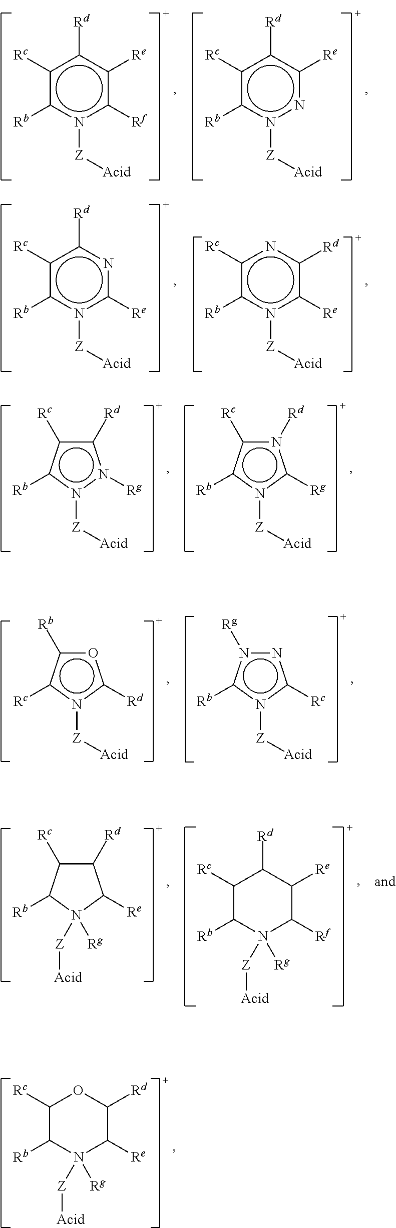

More preferably [Cat⁺-Z-Acid] is selected from:

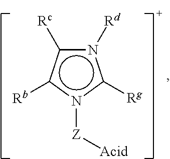

wherein: R^{b}, R^{c}, R^{d}, R^{g}, Acid and Z are as defined above.

Most preferably, [Cat⁺-Z-Acid] is:

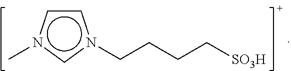

The Cat⁺ moiety in [Cat⁺-Z-Acid] may also be an acyclic cationic moiety. Preferably, the acyclic cationic moiety comprises a group selected from amino, amidino, imino, guanidino, phosphino, arsino, stibino, alkoxyalkyl, alkylthio, alkylseleno and phosphinimino.

Where the Cat⁺ moiety is an acyclic cationic moiety, [Cat⁺-Z-Acid] is preferably selected from:

[N(Z-Acid)(R^{b})(R^{c})(R^{d})]⁺ and [P(Z-Acid)(R^{b})(R^{c})(R^{d})]⁺
wherein: Acid, Z, R^{b}, R^{c}, and R^{d} are as defined above.

In accordance with the present invention, [X⁻] preferably comprises an anionic species selected from: [F]⁻, [Cl]⁻, [Br]⁻, [I]⁻, [OH]⁻, [NCS]⁻, [NCSe]⁻, [NCO]⁻, [CN]⁻, [NO₃]⁻[NO₂]⁻, [(CN)₂N]⁻, [(CF₃)₂N]⁻, [BF₄]⁻, [PF₆]⁻, [SbF₆]⁻, [AsF₆]⁻, [R²₃PF₆]⁻, [HF₂]⁻, [HCl₂]⁻, [HBr₂]⁻, [Hl₂]⁻, [HSO₄]⁻, [SO₄]²⁻, [R²OSO₃]⁻, [HSO₃]⁻, [SO₃]²⁻, [R²OSO₂]⁻, [R¹SO₂O]⁻, [(R¹SO₂)₂N]⁻, [H₂PO₄]⁻, [HPO₄]²⁻, [PO₄]³⁻, [R²OPO₃]²⁻, [(R²O)₂PO₂]⁻, [H₂PO₃]⁻, [HPO₃]²⁻, [R²OPO₂]²⁻, [(R²O)₂PO]⁻, [R¹PO₃]²⁻, [R¹₂PO₂]⁻, [R¹P(O)(OR²)O]⁻, [(R¹SO₂)₃C]⁻, [OR²]⁻, [bisoxalatoborate]⁻, [bismalonatoborate]⁻, [bis(1,2-benzenediolato)borate]⁻, [R²CO₂]⁻, [3,5-d]nitro-1,2,4-triazolate], [4-nitro-triazolate], [2,4-dinitroimidazolate], [4,5-dinitroimidazolate], [4,5-dicyano-imidazolate], [4-nitroimidazolate], and [tetrazolate];
wherein: R¹ and R² are independently selected from the group consisting of C₁-C₁₀ alkyl, C₆ aryl, C₁-C₁₀ alkyl(C₆)aryl, and C₆ aryl(C₁-C₁₀)alkyl each of which may be substituted by one or more groups selected from: fluoro, chloro, bromo, iodo, C₁ to C₆ alkoxy, C₂ to C₁₂ alkoxyalkoxy, C₃ to C₈ cycloalkyl, C₆ to C₁₀ aryl, C₇ to C₁₀ alkaryl, C₇ to C₁₀ aralkyl, —CN, —OH, —SH, —NO₂, —CO₂R^{x}, OC(O)R^{x}, —C(O)R^{x}, wherein each R^{x} is independently selected from hydrogen or C₁ to C₆ alkyl, and wherein R¹ may also be fluorine, chlorine, bromine or iodine.

More preferably, [X⁻] comprises an anionic species selected from: [F]⁻, [Cl]⁻, [Br]⁻, [I]⁻, [OH]⁻, [HSO₄]⁻, [MeSO₄]⁻, [EtSO₄]⁻, [H₂PO₄]⁻, [HPO₄]²⁻, [PO₄]³⁻, [BF₄]⁻, [PF₆]⁻, [SbF₆]⁻, [AsF₆]⁻, [CH₃SO₃]⁻[CH₃(C₆H₄)SO₃]⁻, [CH₃OSO₃]⁻, [C₂H₅OSO₃]⁻, [CF₃SO₃]⁻, [CF₃COO]⁻, [C₂F₅COO]⁻, [CF₃CH₂CH₂COO]⁻, [(CF₃SO₂)₃C]⁻, [CF₃(CF₂)₃SO₃]⁻, [CF₃SO₂)₂N]⁻, [NO₃]⁻, [NO₂]⁻, [bis(1,2-benzenediolato)borate]⁻, [bisoxalatoborate]⁻, [(CN)₂N]⁻, [(CF₃)₂N]⁻, [(C₂F₅)₃PF₃]⁻, [(C₃F₇)₃PF₃]⁻, [(C₂F₅)₂P(O)O]⁻, [SCN]⁻, [C₈H₁₇OSO₃]⁻, [H₃CO(CH₂)₂O(CH₂)OSO₃]⁻, and [H₃C(OCH₂CH₂)ₙOSO₃]⁻, [OR]⁻, [RCO₂]⁻, [HF₂]⁻, [HCl₂]⁻, [HBr₂]⁻, [HI₂]⁻; wherein R is C₁ to C₆ alkyl and n is an integer of from 1 to 5.

Still more preferably, [X⁻] comprises an anionic species selected from the group consisting of: [F]⁻, [Cl]⁻, [Br]⁻, [EtSO₄]⁻, [CH₃SO₃]⁻, [(CF₃SO₂)₂N]⁻ and [CF₃SO₃]⁻. Still more preferably, [X⁻] comprises an anionic species selected from the group consisting of: [F]⁻, [Cl]⁻, [Br]⁻, [I]⁻, and most preferably [X⁻] comprises [Cl]⁻.

In an alternative embodiment, [X⁻] may comprise a basic anion selected from: [F]⁻, [Cl]⁻, [OH]⁻, [OR]⁻, [RCO₂]⁻, [PO₄]³⁻ and [SO₄]²⁻, wherein R is C₁ to C₆ alkyl.

In another alternative embodiment, [X⁻] may comprise an acidic anion selected from: [HSO₄]⁻, [H₂PO₄]⁻, [HPO₄]²⁻, [HF₂]⁻, [HCl₂]⁻, [HBr₂]⁻ and [HI₂]⁻.

The present invention is not limited to ionic liquids comprising anions and cations having only a single charge. Thus, the formula [Cat⁺][X⁻] is intended to encompass ionic liquids comprising, for example, doubly, triply and quadruply charged anions and/or cations. The relative stoichiometric amounts of [Cat⁺] and [X⁻] in the ionic liquid are therefore not fixed, but can be varied to take account of cations and anions with multiple charges. For example, the formula [Cat⁺][X⁻] should be understood to include ionic liquids having the formulae [Cat⁺]₂[X²⁻]; [Cat²⁺][X^{-]}₂; [Cat²⁺][X²⁻]; [Cat⁺]₃[X³⁻], [Cat³⁺][X⁻]₃ and so on.

It will also be appreciated that the present invention is not limited to ionic liquids comprising a single cation and a single anion. Thus, [Cat⁺] may, in certain embodiments, represent two or more cations, such as a statistical mixture of 1,3-dimethylimidazolium, 1-ethyl-3-methylimidazolium and 1-3-diethylimidazolium. Similarly, [X⁻] may, in certain embodiments, represent two or more anions, such as a mixture of chloride ([Cl⁻]) and bistriflimide ([N(SO₂CF₃)₂]⁻).

In accordance with the present invention, the ionic liquid is preferably liquid at a temperature of 100° C. or less, more preferably, 80° C. or less, still more preferably 60° C. or less, and even more preferably 40° C. or less. Most preferably, the ionic liquid is liquid at room temperature, where room temperature is defined as between 20° C. and 25° C.

In accordance with the present invention, the ionic liquid is preferably water-free, wherein water-free may be defined as less than 5% by weight of water, more preferably less than 2% by weight of water, still more preferably less than 1% by weight of water, still more preferably less than 0.5% by weight of water, and most preferably less than 0.1% by weight of water.

As noted above, the process of the present invention is directed to joining two or more substrates by soldering, wherein the substrates to be joined each have a surface comprising a transition metal, aluminium, thallium, tin, lead, or bismuth, or an alloy thereof at the position where the substrate is to be soldered to another substrate.

In accordance with the present invention, the two or more substrates can be the same or different, and may be formed of any suitable solid material provided that at least a first surface of each of the substrates is provided with a layer comprising a transition metal, aluminium, thallium, tin, lead, or bismuth, or an alloy thereof.

In a preferred embodiment, at least one of the substrates is provided with a layer comprising a transition metal or an alloy thereof.

More preferably, at least one of the substrates is provided with a layer comprising a transition metal selected from groups VIIIB and IB of the Periodic Table of the Elements (i.e. iron, ruthenium, osmium, cobalt, rhodium, iridium, nickel, palladium, platinum, copper, silver and gold), or an alloy thereof.

Still more preferably, at least one of the substrates is provided with a layer comprising a transition metal selected from group IB of the Periodic Table of the Elements (i.e. copper, silver and gold), or an alloy thereof.

Thus, in one preferred embodiment, at least one of the substrates is provided with a layer comprising gold. In another preferred embodiment, at least one of the substrates is provided with a layer comprising silver. In a further preferred embodiment, at least one of the substrates is provided with a layer comprising copper.

Still more preferably, each of the substrates is provided with a layer of any of the preferred types disclosed above.

In a further embodiment, each of the substrates has a first surface formed of gold, silver or copper, or an alloy formed exclusively of two or more of gold, silver and copper in any proportion. More preferably, the substrates have a first surface formed of one of gold, silver or copper. Still more preferably, the substrates have a first surface formed of gold or silver, and most preferably the substrates have a first surface formed of gold.

In yet another embodiment, at least one of the substrates, and more preferably each of the substrates, has a first surface that does not comprise gold.

As used herein, the term “alloy” refers to an alloy formed exclusively of two or more of the above metals in any proportion. The term also includes alloys formed with one or more of the above metals together with one or more other metals. Preferably, such alloys comprise at least 50 mol % of the above metals, more preferably at least 60 mol %, still more preferably at least 70 mol %, still more preferably at least 80 mol %, still more preferably at least 90 mol %, still more preferably at least 95 mol %, and most preferably at least 98 mol % of the above metals.

Suitable substrates for use according to the present invention include glass, resin, plastic, metal, ceramic, a semiconductor, glassy carbon, graphite, silica or alumina, provided that at least one surface of the substrate is provided with a layer comprising a transition metal, aluminium, thallium, tin, lead, or bismuth, or an alloy thereof.

In a preferred embodiment, one or more of the substrates is a metal. More preferably each of the substrates is a metal. Suitable metal substrates include substrates formed entirely from a transition metal, aluminium, thallium, tin, lead bismuth, or an alloy thereof. Alternatively, suitable metal substrates may have at least one surface that is provided with a layer of a transition metal, aluminium, thallium, tin, lead, or bismuth, or an alloy thereof, wherein said layer is different from the substrate metal.

In accordance with the present invention, a layer of solder metal as defined above is deposited onto the first surface of at least a first substrate by electrolysis of an electrodeposition mixture comprising an ionic liquid as defined above and a salt or salts of the solder metal, wherein the layer of solder metal comprises indium, gallium or a mixture thereof.

Preferably the salt(s) of the solder metal is selected from indium halides and gallium halides, or mixtures thereof. More preferably the salt of the solder metal is selected from indium(III) chloride and/or gallium(III) chloride salts and/or mixtures thereof. These salts are believed to form anionic complexes when dissolved in ionic liquids. For example, when dissolved in ionic liquids having a chloride anion, indium(III) chloride and gallium(III) chloride are believed to form [InCl₅]²⁻ and [GaCl₄]⁻ complexes respectively. These chloroindate and chlorogallate ionic liquids are stable to air and moisture (in contrast with the related chloroaluminate ionic liquids), and are therefore easy to handle.

The electrodeposition mixture is simply prepared by dissolving the salt(s) of the solder metal in the ionic liquid. In a preferred embodiment the ionic liquid and the salt(s) of the solder metal are combined in a molar ratio of from 99:1 to 25:75, more preferably 95:5 to 50:50, still more preferably 90:10 to 50:50, and most preferably 80:20 to 50:50. For example, the electrodeposition mixture may contain 80 mol % of the ionic liquid and 20 mol % of the salt(s) of the solder metal; or 75 mol % of the ionic liquid and 25 mol % of the salt(s) of the solder metal; or 67 mol % of the ionic liquid and 33 mol % of the salt(s) of the solder metal; or 60 mol % of the ionic liquid and 40 mol % of the salt(s) of the solder metal.

In one embodiment, the deposited solder metal is indium. In a further embodiment the deposited solder metal is gallium. In still further embodiments the deposited solder metal is a mixture of indium and gallium in a weight ratio of from 99:1 to 1:99. For example, the weight ratio of indium and gallium in the solder metal may be 90:10, 80:20, 70:30, 60:40, 50:50, 40:60, 30:70, 20:80, or 10:90.

In order to deposit the solder metal onto the first surface of a substrate, the first surface of the substrate is immersed in a bath of the electrodeposition mixture. Also immersed in the electrodeposition mixture is a counter-electrode. A potential difference is applied across the counter-electrode and the first surface of the substrate (the working electrode) to enable electrodeposition of the solder metal onto the first surface of the substrate to take place. A person skilled in the art is capable of selecting a suitable electrodeposition conditions to obtain the desired electrodeposited layer by routine experimental procedures.

The material used to form the counter electrode is not especially limited. Thus, the counter electrode may be made from a metal, a semiconductor or glassy carbon. The counter electrode may, for instance, be made of platinum, such as a platinum coil.

The process may further comprise a third electrode as a reference electrode. Where present, the third electrode is preferably made of silver. Where the third electrode is silver, it preferably has a deposition potential of −2 V vs. Ag/Ag⁺.

It will be appreciated that the amount of solder metal deposited onto the first surface of the substrate is a function of the potential difference applied across the cathode and the anode and the length of time the potential difference is applied for. A person skilled in the art is capable of selecting suitable conditions in this respect, however the voltage applied would typically be in the range of −1.0 to −2.0 V vs Ag/Ag⁺, more preferably in the range of −1.25 to −1.75 V vs Ag/Ag⁺, and most preferably around −1.5 V vs Ag/Ag⁺.

The electrodeposition process may generally be carried out over a period of one minute to one hour. For example, the electrodeposition process may be carried out over a period of 2 minutes to 30 minutes, or 5 minutes to 10 minutes.

The electrodeposited layer of solder metal preferably has a thickness in the range of from 5 to 500 μm. For example, the layer of solder metal may have a thickness in the range of from 5 to 200 μm, or from 10 to 100 μm. Further examples include where the layer of solder metal has a thickness of 10 μm, 20 μm, 30 μm, 40 μm, 50 μm, 60 μm, 70 μm, 80 μm, 90 μm, or 100 μm.

The electrodeposition process is preferably conducted at a temperature of 100° C. or less, more preferably 80° C. or less, still more preferably 60° C. or less, even more preferably 40° C. or less, and most preferably 25° C. or less.

In further embodiments, the electrodeposition process is preferably conducted at a temperature of at least 0° C., more preferably at least 10° C., and even more preferably at least 15° C.

Most preferably, the electrodeposition process is conducted at room temperature, where room temperature is defined as between 20° C. and 25° C. Conducting the electrodeposition process at room temperature is preferred as it reduces the energy cost associated with high temperature processes.

Once the solder metal has been deposited onto the first surface of at least one of the substrates, the substrate can be fused to the at least one other substrate by contacting the deposited layer of solder metal with the first surface of the at least one other substrate (or optionally with layer of the solder metal provided on the first surface of the at least one other substrate), and heating the solder metal to a temperature of 160° C. or less so as to fuse the first substrate to the at least one other substrate.

It will be appreciated that the lowest temperature required to fuse the substrates will depend on the composition of the deposited solder metal. In a preferred embodiment, the substrates are fused at a temperature of 140° C. or less, more preferably 120° C. or less, more preferably 100° C. or less, more preferably 80° C. or less, more preferably 60° C. or less, and most preferably 40° C. or less. In a further embodiment, the substrates are fused at a temperature of 30° C. or less, for example the substrates may be fused simply by contacting the substrates at room temperature, where room temperature is defined as 20 to 25° C.

In further preferred embodiments, the first substrate is fused to the at least one other substrate at a temperature of at least 15° C., more preferably at least 20° C. In still further embodiments, the first substrate is fused to the at least one other substrate at a temperature of at least 30° C., at least 40° C., at least 60° C., at least 80° C., or at least 100° C.

In a further preferred embodiment, the deposited solder metal has a melting point of 157° C. or less. For example, the deposited solder metal may have a melting point of 140° C. or less, more preferably 120° C. or less, more preferably 100° C. or less, more preferably 80° C. or less, more preferably 60° C. or less, and most preferably 40° C. or less. In a further preferred embodiment, the deposited solder metal has a melting point of 30° C. or less, for example 20 to 25° C.

Preferably sufficient pressure to maintain good contact between the substrates is applied during melting of the solder metal, and the pressure is maintained as the solder metal cools to ensure the formation of an effective joint.

Joints between substrates formed in accordance with the methods of the present invention have been found to have improved fatigue life and improved mechanical properties to those formed by conventional soldering methods.

Without being bound by any theory, it is believed that the electrodeposited solder metal may react with the metal layer on the substrate surfaces to form an intermetallic layer. Formation of the intermetallic layer is believed to fuse the substrates together. In addition, in some embodiments the intermetallic layer has a melting point higher than that of the electrodeposited solder metal, and accordingly the joints formed according to the present invention are thermally stable, even when formed at low temperatures.

More specifically, X-ray diffraction analysis has shown the formation of AuIn₂ and AuGa₂ at the interface of gold substrates fused according to the present invention using an electrodeposited indium or gallium layer, respectively. AuIn₂ and AuGa₂ are stable alloys having a high heat of formation, and it believed to be the formation of these, and similar, compounds which gives rise to the exceptional mechanical properties and fatigue life of joints formed in accordance with the present invention.

In a further embodiment, the process of the present invention may comprise an annealing step, wherein the soldered joint is heated for a period of time so as to promote the formation of additional intermetallic compounds and to further increase the remelting temperature of the soldered joint. Suitable annealing temperatures depend on the composition of the solder metal and the nature of the substrate surfaces to be joined. However, suitable annealing processes may be conducted at temperatures of up to 150° C., for examples up to 130° C., up to 110° C., up to 90° C., up to 70° C. or up to 50° C. Preferably annealing is conducted at a temperature of at least 40° C. Suitable timescales for the annealing step range from 1 minute to several hours, for example from 1 minute to 1 day, from 1 minute to 10 hours, or from 1 minute to 1 hour.

In a further embodiment, the present invention provides an article formed by a soldering process as described above.

In a further embodiment, the present invention provides an article comprising a first substrate and at least one other substrate, wherein each substrate has a first surface of a transition metal, aluminium thallium, tin, lead, or bismuth, or an alloy thereof, and wherein the first surface of the first substrate is fused to the first surface of the at least one other substrate by an intermediate indium- or gallium-containing layer.

The present invention further provides the use of a mixture comprising an ionic liquid and an indium or gallium salt in a soldering process.

The present invention will now be described by way of example, and with reference to the accompanying Figures in which:

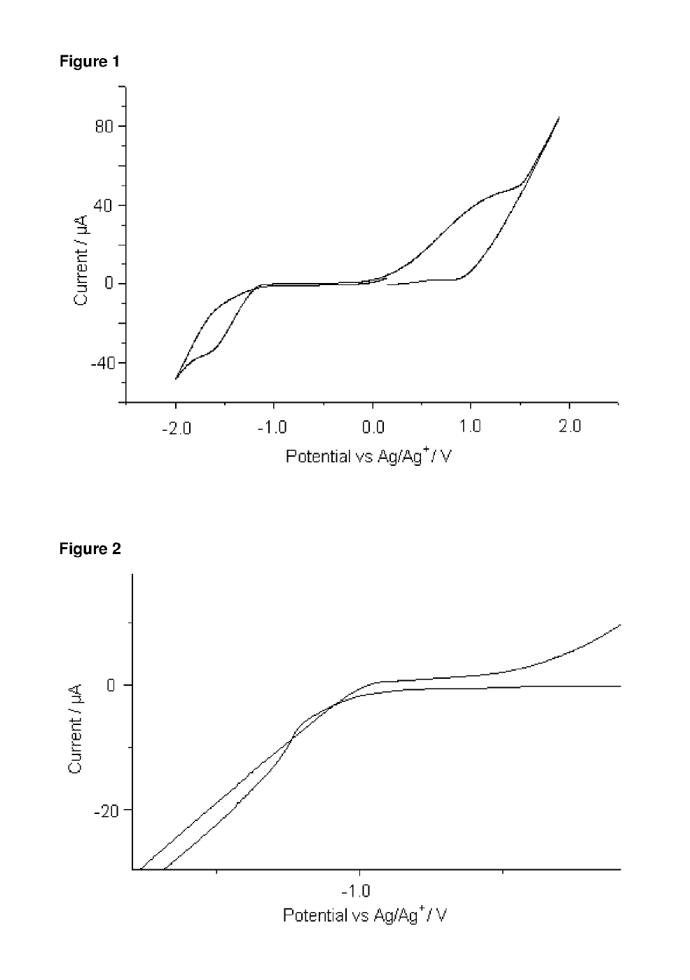

FIG. 1 is a cyclic voltammogram of an electrodeposition mixture comprising 33 mol % InCl₃ and 67 mol % 1-octyl-3-methylimidazolium chloride ([omim][Cl]) on a gold electrode;

FIG. 2 is an inset of the cyclic voltammogram of FIG. 1, depicting the nucleation loop;

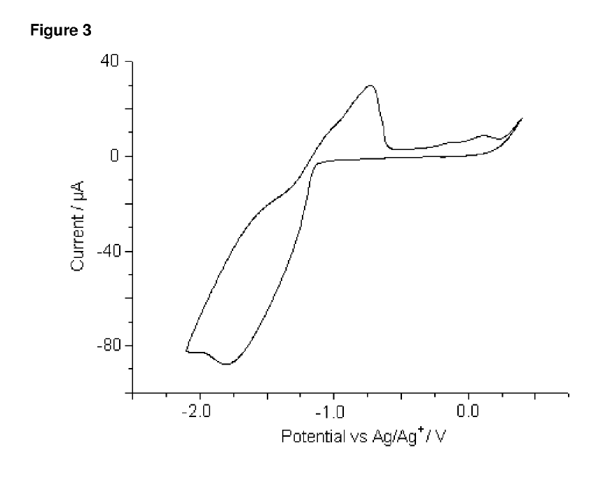

FIG. 3 is a cyclic voltammogram of an electrodeposition mixture comprising 33 mol % InCl₃ and 67 mol % [omim][Cl] on a gold electrode after 300 s;

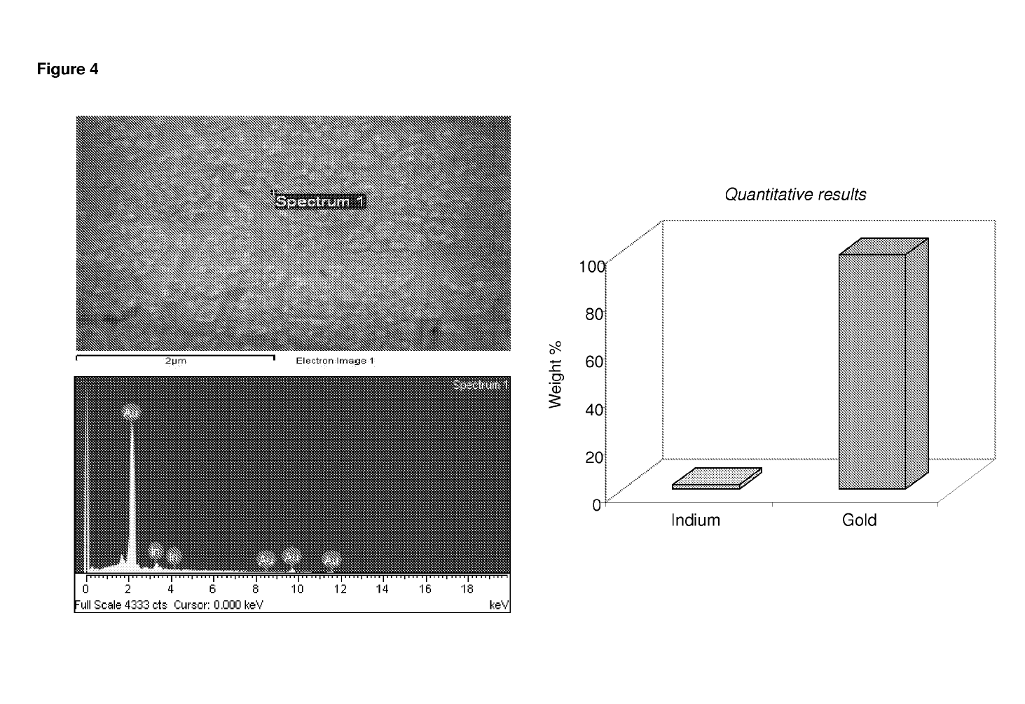

FIG. 4 shows data from a scanning electron microscope (SEM) and energy dispersive X-ray spectroscopy (EDAX) of deposits on a gold electrode produced from an electrodeposition mixture comprising 33 mol % InCl₃ and 67 mol % [omim][Cl];

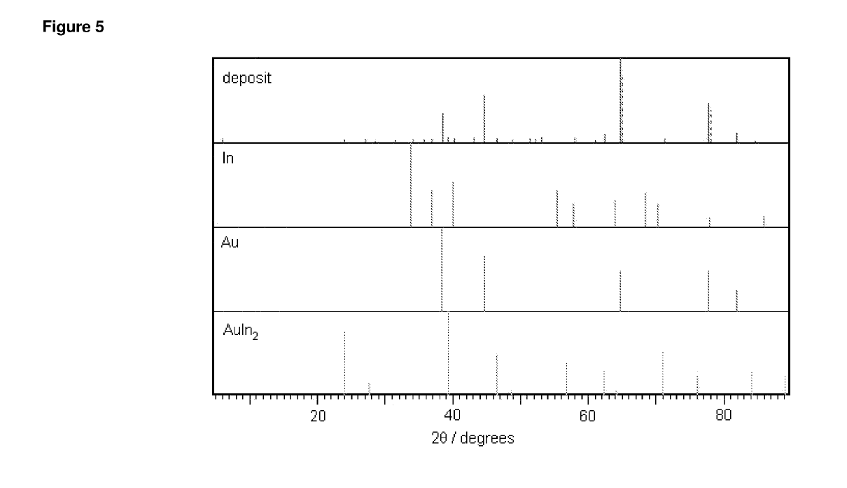

FIG. 5 compares the X-ray diffraction (XRD) pattern of deposits produced from an electrodeposition mixture comprising 33 mol % InCl₃ and 67 mol % [omim][Cl] with the XRD patterns of indium, gold and alloy AuIn₂;

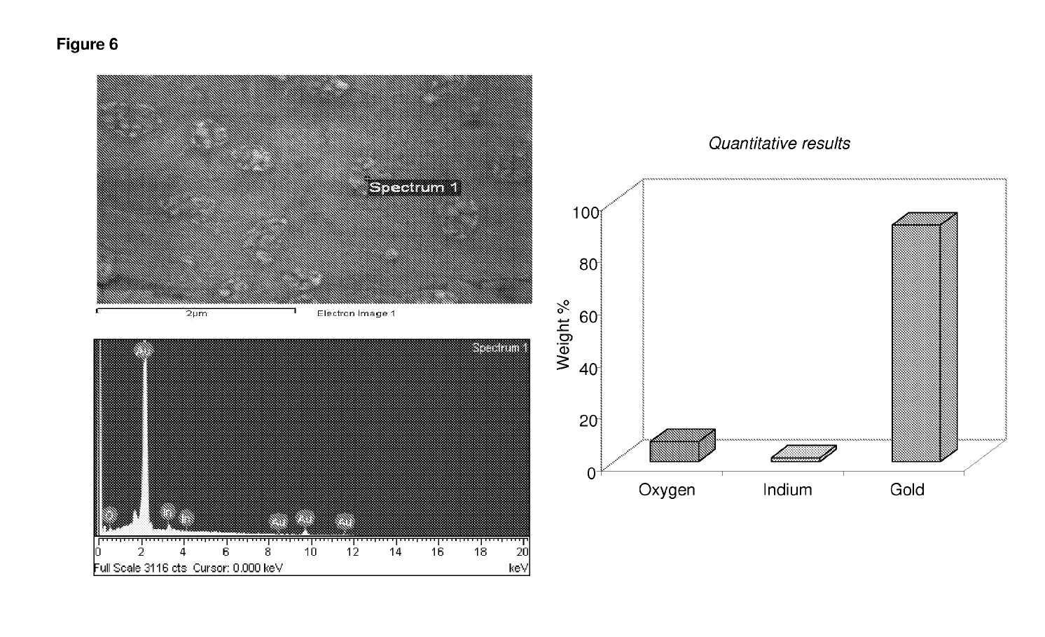

FIG. 6 shows SEM and EDAX data from an experiment in which indium deposits are produced from an electrodeposition mixture comprising 25 mol % InCl₃ and 75 mol % [omim][Cl];

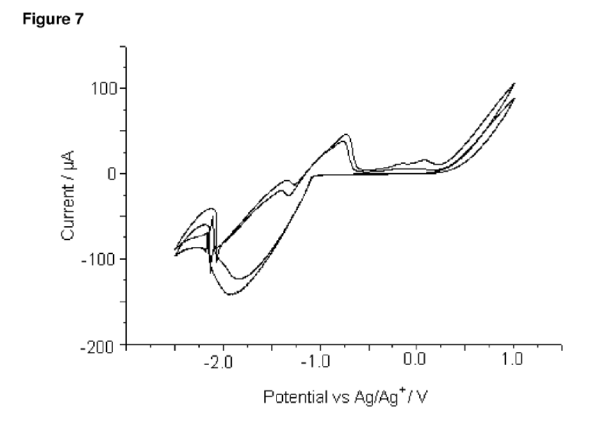

FIG. 7 is a cyclic voltammogram of an electrodeposition mixture comprising 33 mol % InCl₃ and 67 mol % pyrrolidinium chloride on a gold electrode;

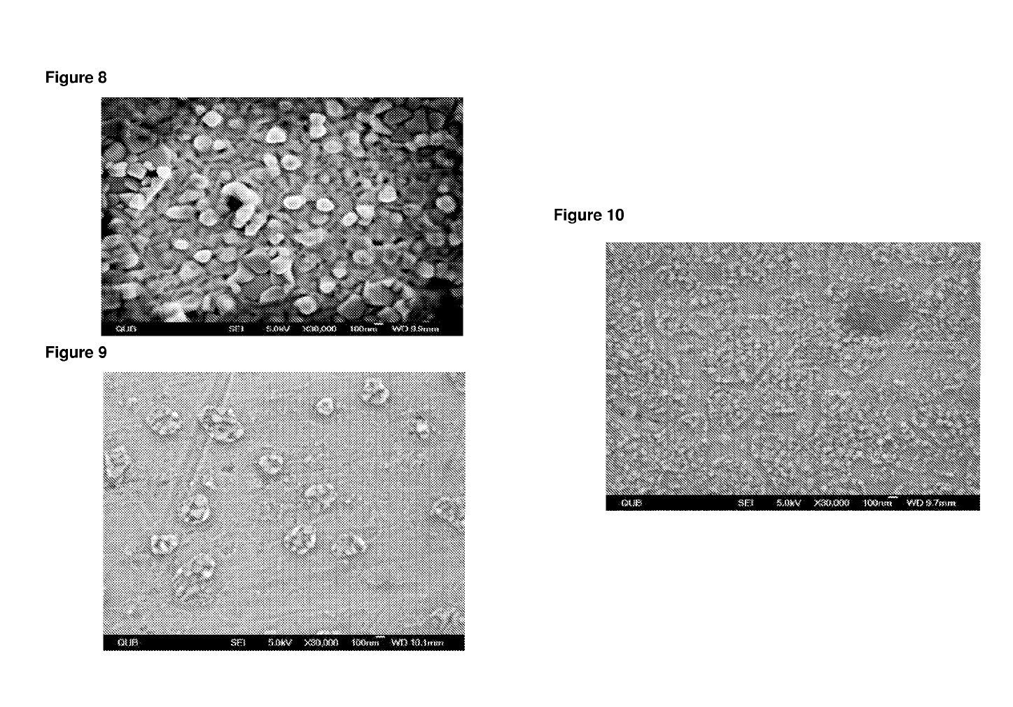

FIGS. 8 to 10 show the SEM images of deposits on a gold electrode from electrodeposition mixtures comprising 33 mol % InCl₃ and 67 mol % pyrrolidinium chloride, 25 mol % InCl₃ and 75 mol % [omim][Cl], and 33 mol % InCl₃ and 67 mol % [omim][Cl] on a gold electrode;

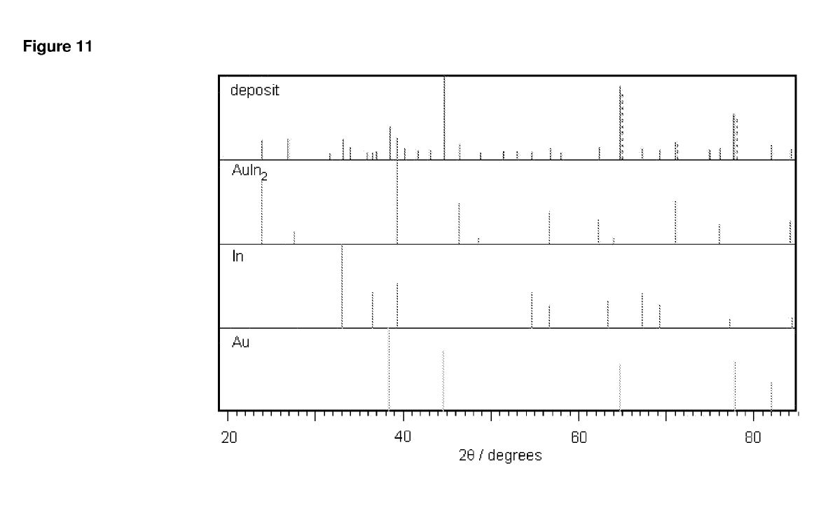

FIG. 11 compares the XRD pattern of deposits produced from an electrodeposition mixture comprising 33 mol % InCl₃ and 67 mol % pyrrolidinium chloride with the XRD patterns of indium, gold and alloy AuIn₂;

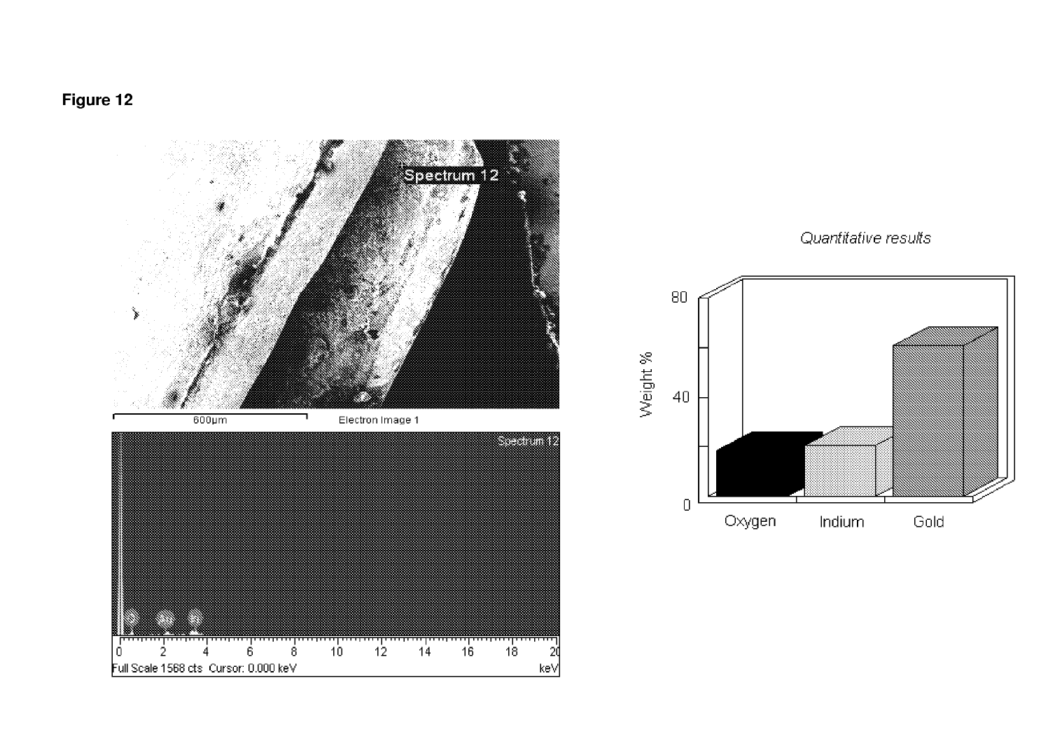

FIG. 12 shows SEM and EDAX data of the joint made by pressing two pieces of gold coated with indium together;

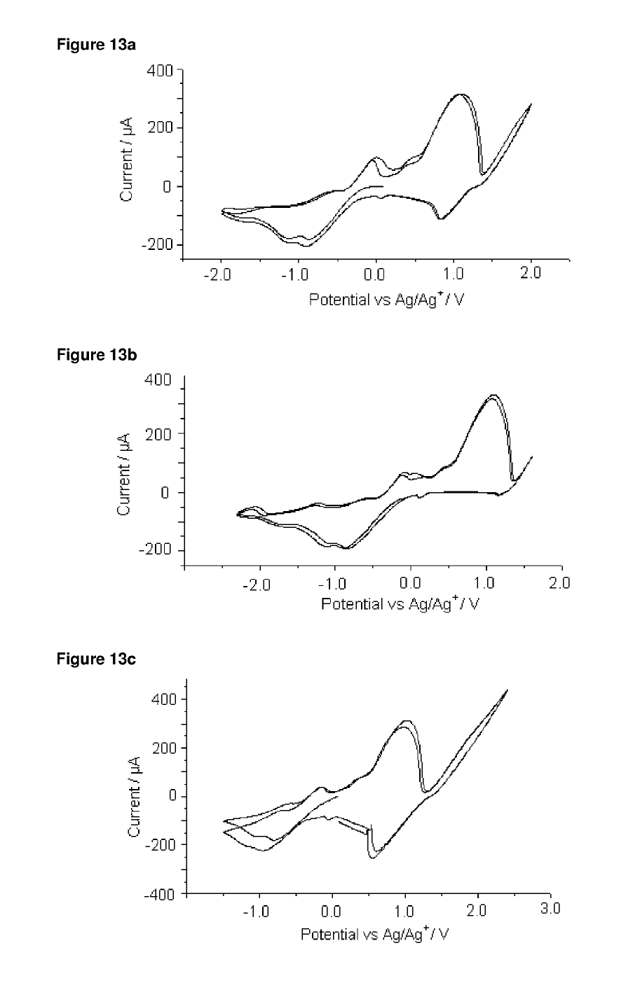

FIGS. 13a-c are cyclic voltammograms of an electrodeposition mixture comprising 55 mol % GaCl₃ and 45 mol % 1-octyl-3-methylimidazolium chloride ([omim][Cl]) on a gold electrode;

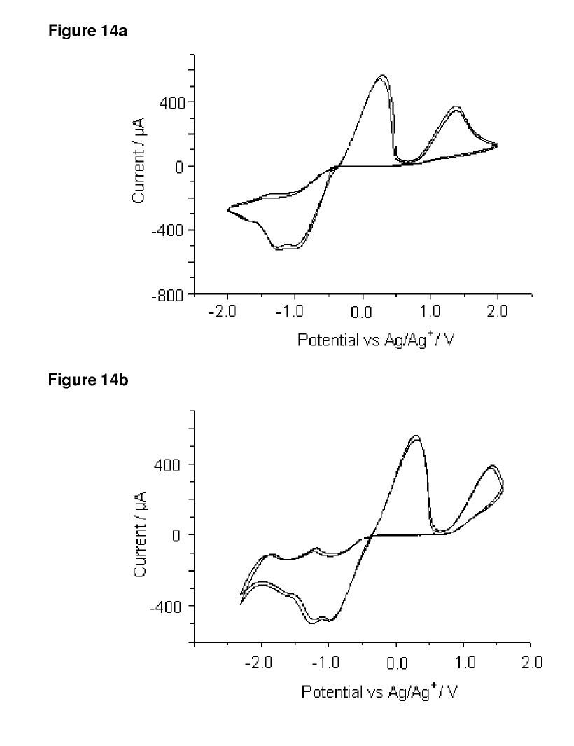

FIGS. 14a-b are cyclic voltammograms of an electrodeposition mixture comprising 55 mol % GaCl₃ and 45 mol % 1-octyl-3-methylimidazolium chloride ([omim][Cl]) on a platinum electrode;

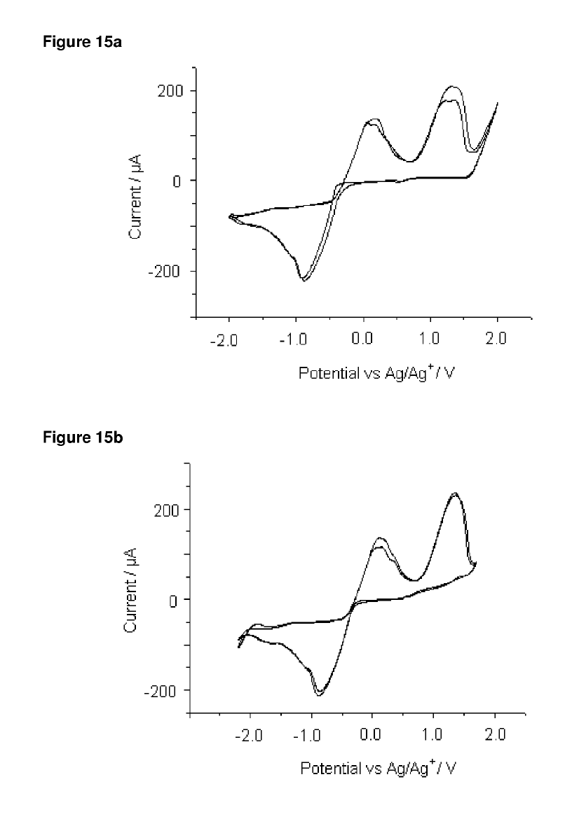

FIGS. 15a-b are cyclic voltammograms of an electrodeposition mixture comprising 55 mol % GaCl₃ and 45 mol % 1-octyl-3-methylimidazolium chloride ([omim][Cl]) on a glassy carbon electrode;

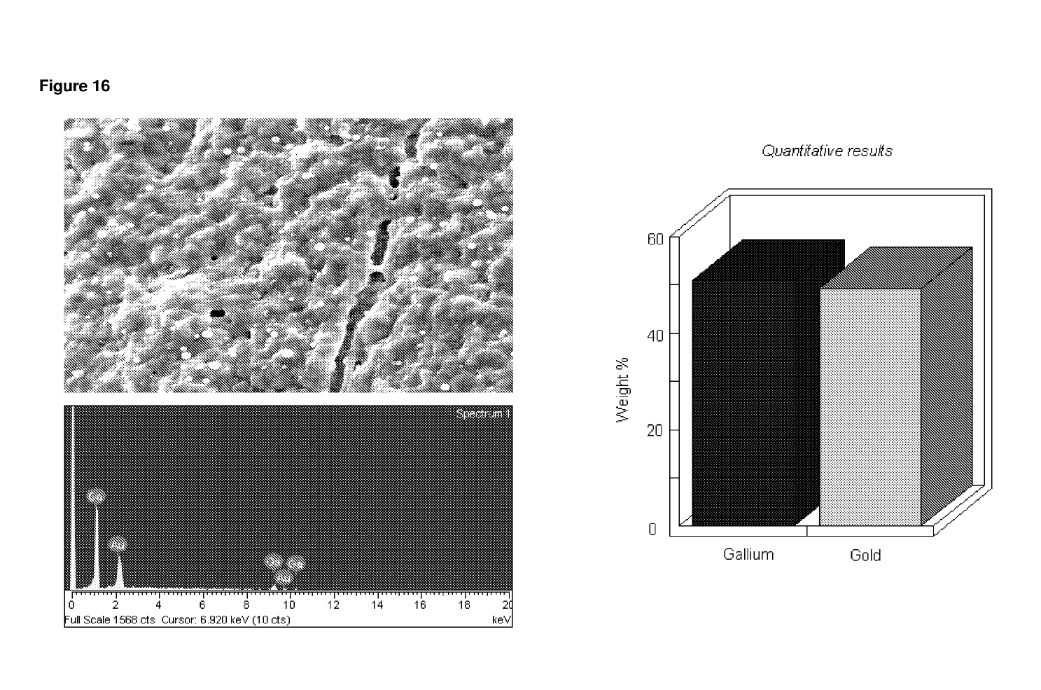

FIG. 16 shows SEM and EDAX data of deposits on a gold electrode produced from an electrodeposition mixture comprising 33 mol % GaCl₃ and 67 mol % [omim][Cl];

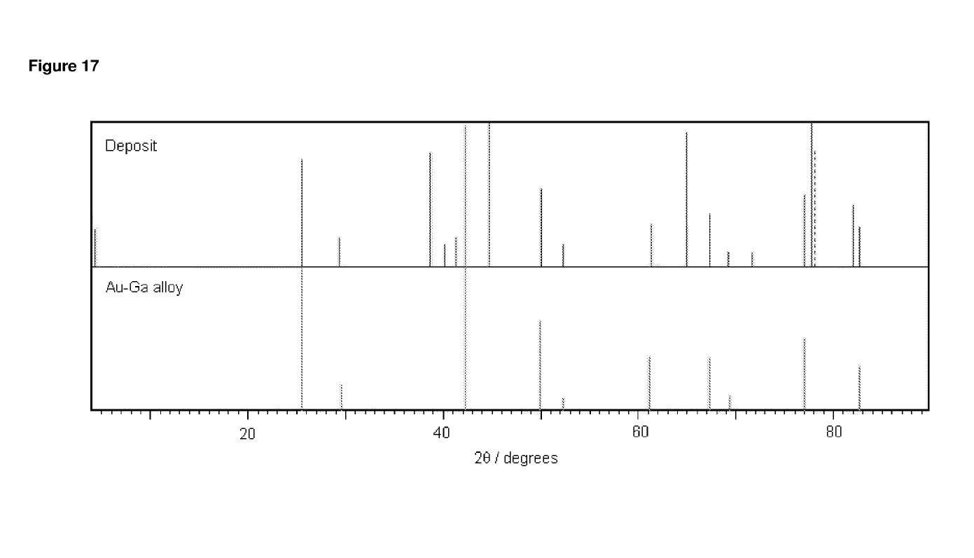

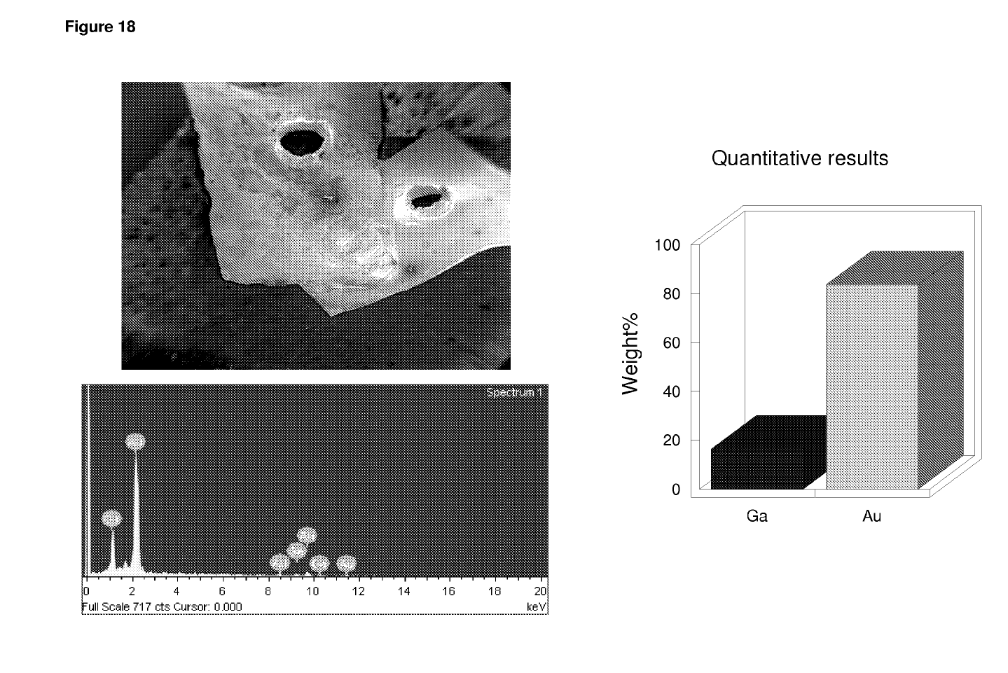

FIG. 17 compares the XRD pattern of deposits produced from an electrodeposition mixture comprising 33 mol % GaCl₃ and 67 mol % [omim][Cl] with the XRD patterns of a Au—Ga alloy; and

FIG. 18 shows SEM and EDAX data of the joint made by pressing two pieces of gold coated with gallium together.

### EXAMPLES

Voltammetric experiments were carried out in a 10 cm³ glass cell fitted with an inlet for bubbling argon. The current potential curves were recorded with a PC controlled Potentiostat/Galvanostat EG&G Model 273 using the three-electrode method.
Cyclic voltammogram experiments were performed with a three-electrode arrangement with gold working electrode, a bright platinum wire used as the counter electrode. Potentials were measured with respect to a Ag/Ag⁺ as the reference electrode and the IR-drop was compensated by using a feedback circuit incorporated in the potentiostat.
A magnetic stirrer was used to stir the contents of the cell during the electrolysis and the experiments were carried out at room temperature [20° C.] using a thermostatic bath.
Before bubbling into the cell, Ar was dried using a molecular sieves (4 Å)/silica gel/P₂O₅ drying column connected directly to the gas cylinder.
SEM characterization studies were done using Jeol JSM 6500 F Scanning Electron microscope instrument and EDAX studies were carried out using INCA Energy Dispersive X-Ray spectroscope. XRD studies were carried out using PAnalytical X-Ray machine.

### Example 1

A cyclic voltammetry experiment was conducted to analyse the electrochemical behaviour of an electrodeposition mixture comprising 33 mol % InCl₃ and 67 mol % 1-octyl-3-methylimidazolium chloride ([omim][Cl]). The deposition of indium on a working electrode of 0.25 mm thickness gold foil was observed at a scanning rate of 100 mV/s and with a vertex delay of 180 seconds.

The cyclic voltammogram obtained (see FIG. 1) shows that smooth electrochemical deposition of indium on gold surface was achieved. A nucleation loop was observed at −1.23V vs. Ag/Ag⁺ which corresponds to the reduction of indium to its metallic state and its deposition on the working electrode. The nucleation loop is enlarged in FIG. 2. The nucleation loop is attributed to the deposition of indium metal on the clean gold surface for the first time. The deposition of indium was found to be irreversible for the first few cycles of the experiment, and the hump around 1.2 V corresponds to chlorine oxidation. The deposition of indium metal was observed as the formation of a silvery deposit on the surface of the gold.

After 5 minutes of electrodeposition of indium, the deposition process becomes reversible, and indium begins to be deposited onto the surface of the indium layer already formed on the gold substrate. The absence of a nucleation loop can be seen in FIG. 3.

The deposits were analysed by scanning electron microscopy (SEM) and energy-dispersive X-ray spectroscopy (EDAX), and show indium clusters deposited on the surface of the gold substrate (FIG. 4).

X-ray diffraction (XRD) studies were carried out to identify the nature of the indium deposit on gold. The XRD patterns from the deposit were compared with those from pure indium and gold (FIG. 5). The XRD pattern was also compared with the alloy AuIn₂. The XRD pattern of the deposit shows a strong intensity match with the XRD pattern of gold, a small match with the alloy and a smaller match with indium.

### Example 2

A cyclic voltammetry experiment was conducted to analyse the electrochemical behaviour of an electrodeposition mixture comprising 25 mol % InCl₃ and 75 mol % [omim][Cl]. Compared to the deposition observed in Experiment 1, the deposition was not very uniform, with clusters quite far away from each other.

The EDAX spectrum of a deposited cluster shows the presence of indium (FIG. 6).

### Example 3

A cyclic voltammetry experiment was conducted to analyse the electrochemical behaviour of basic chloroindate ionic liquids comprising 33 mol % InCl₃ and 67 mol % pyrrolidinium chloride. Thick, smooth electrodeposition of indium on gold was observed (FIG. 7). A nucleation loop was not observed because indium metal covered the gold electrode surface rapidly.

The deposits were analysed by SEM and EDAX and a crystalline and more uniform deposition was observed than in the case of InCl₃ and [omim][Cl]. FIGS. 8-10 give a comparison of SEM studies of the deposition of indium on gold from 33 mol % InCl₃ and 67 mol % pyrrolidinium chloride, 25 mol % InCl₃ and 75 mol % [omim][Cl], and 33 mol % InCl₃ and 67 mol % [omim][Cl], respectively. All were captured in the same magnification.

The XRD patterns of the deposit produced from an electrodeposition mixture comprising 33 mol % InCl₃ and 67 mol % pyrrolidinium chloride shows a stronger intensity match with the XRD pattern of the alloy than with the XRD pattern of pure gold and indium (FIG. 11).

### Example 4

Two pieces of gold coated with indium on one side were joined together at the point of deposition by heating to 160° C. The two pieces stuck together and formed a joint strong enough to withstand manual pressure.

The joint was analysed by SEM and EDAX (FIG. 12). Compositional changes were observed, with the presence of oxygen observed. The morphology also changed, with loss of the crystallinity that was observed on deposition.

### Example 5

A cyclic voltammetry experiment was conducted to analyse the electrochemical behaviour of an electrochemical mixture comprising 55 mol % GaCl₃ and 45 mol % [omim][Cl] on a gold, platinum and glassy carbon electrode (FIGS. 13a, 14a and 15a). Experiments were also conducted with the electrochemical window extended on either the cathodic side (FIGS. 13b, 14b and 15b) or the anodic side (FIG. 13c) in order to identify new peaks. The cathodic window was limited by the deposition of the gallium metal and the anodic side by the oxidation of chlorine. Some shifts in peak potentials were observed.

Deposition was carried out on Au electrode by holding the potential at the cathode. Some under potential deposition of gallium was observed, with stripping out observed at two different potentials on the anodic scan.

The deposits were analysed by SEM and EDAX (FIG. 16) and show gallium deposited on the surface of the gold electrode.

The XRD studies were carried out for the gallium deposits (FIG. 17) and on the joint portion and were compared with the reference library data. Both XRD patterns showed their strongest intensity match with the XRD pattern of a Au—Ga alloy.

### Example 6

Two pieces of gold coated with gallium on one side were joined together at the point of deposition by squeezing at 35° C. The two pieces stuck together and formed a joint strong enough to withstand manual pressure.

The joint was analysed by SEM and EDAX (FIG. 18). Compositional changes were observed, with the presence of oxygen observed. The morphology also changed, with loss of the crystallinity that was observed on deposition.

1. A soldering process comprising the steps of:
a) providing at least two substrates, wherein each substrate has a first surface comprising a transition metal, aluminium, thallium, tin, lead, or bismuth, or an alloy thereof;
b) depositing a layer of a solder metal onto the first surface of at least one of the substrates by electrolysis of an electrodeposition mixture comprising an ionic liquid and a salt of the solder metal;
c) contacting the deposited layer of the solder metal with the first surface of the at least one other substrate or with a layer of the solder metal deposited thereon at a temperature of 160° C. or less so as to fuse the substrates;
wherein the deposited layer of the solder metal comprises indium, gallium, or a mixture thereof.

2. A soldering process according to claim 1, wherein the solder metal comprises gallium or an alloy of indium and gallium, and wherein the first substrate is fused to the at least one other substrate at a temperature of from 20° C. to 25° C.

3. A soldering process according to claim 1, wherein electrolysis of the electrodeposition mixture is conducted at a temperature of from 0° C. to 100° C.

4. A soldering process according to claim 1, wherein electrolysis of the electrodeposition mixture is conducted at a temperature of from 20° C. to 25° C.

5. A process according to claim 1, wherein the ionic liquid has the formula:
[Cat⁺][X⁻];
wherein:
[Cat⁺] represents one or more cationic species; and
[X⁻] represents one or more anionic species.

6. A process according to claim 5, wherein [Cat⁺] comprises a cationic species selected from: ammonium, azaannulenium, azathiazolium, benzimidazolium, benzofuranium, benzotriazolium, borolium, cinnolinium, diazabicyclodecenium, diazabicyclononenium, diazabicyclo-undecenium, dithiazolium, furanium, guanidinium, imidazolium, indazolium, indolinium, indolium, morpholinium, oxaborolium, oxaphospholium, oxazinium, oxazolium, iso-oxazolium, oxathiazolium, pentazolium, phospholium, phosphonium, phthalazinium, piperazinium, piperidinium, pyranium, pyrazinium, pyrazolium, pyridazinium, pyridinium, pyrimidinium, pyrrolidinium, pyrrolium, quinazolinium, quinolinium, iso-quinolinium, quinoxalinium, selenozolium, sulfonium, tetrazolium, iso-thiadiazolium, thiazinium, thiazolium, thiophenium, thiuronium, triazadecenium, triazinium, triazolium, iso-triazolium, and uronium.

7. A process according to claim 6, wherein [Cat⁺] comprises a cationic species selected from: 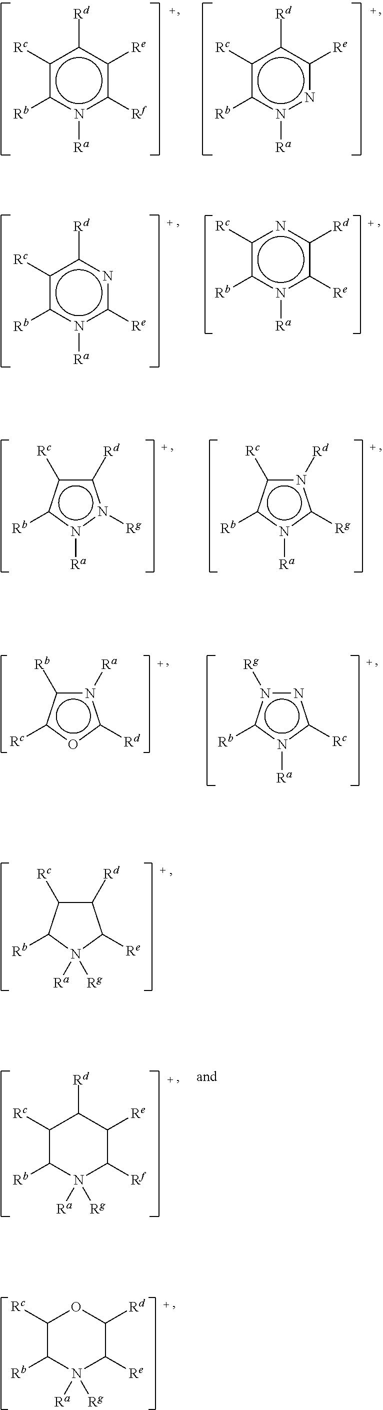
wherein: R^{a}, R^{b}, R^{c}, R^{d}, R^{e}, R^{f} and R^{g} are each independently selected from hydrogen, a C₁ to C₃₀, straight chain or branched alkyl group, a C₃ to C₈ cycloalkyl group, or a C₆ to C₁₀ aryl group, or any two of R^{b}, R^{b}, R^{d}, R^{e} and R^{f} attached to adjacent carbon atoms form a methylene chain —(CH₂)_{q}— wherein q is from 3 to 6; and wherein said alkyl, cycloalkyl or aryl groups or said methylene chain are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, C₇ to C₁₀ alkaryl, C₇ to C₁₀ aralkyl, —CN, —OH, —SH, —NO₂, —CO₂R^{x}, —OC(O)R^{x}, —C(O)R^{x}, —C(S)R^{x}, —CS₂R^{x}, —SC(S)R^{x}, —S(O)(C₁ to C₆)alkyl, —S(O)O(C₁ to C₆)alkyl, —OS(O)(C₁ to C₆)alkyl, —S(C₁ to C₆)alkyl, —S—S(C₁ to C₆ alkyl), —NR^{x}C(O)NR^{y}R^{z}, —NR^{x}C(O)OR^{y}, —OC(O)NR^{y}R^{z}, —NR^{x}C(S)OR^{y}, —OC(S)NR^{y}R^{z}, —NR^{x}C(S)SR^{y}, —SC(S)NR^{y}R^{z}, —NR^{x}C(S)NR^{y}R^{z}, —C(O)NR^{y}R^{z}, —C(S)NR^{y}R^{z}, —NR^{y}R^{z}, or a heterocyclic group, wherein R^{x}, R^{y} and R^{z} are independently selected from hydrogen or C₁ to C₆ alkyl.

8. A process according to claim 6, wherein [Cat⁺] comprises a cationic species selected from:
[N(R^{a})(R^{b})(R^{c})(R^{d})]⁺, [P(R^{a})(R^{b})(R^{c})(R^{d})]⁺, and [S(R^{a})(R^{b})(R^{c})]⁺,
wherein: R^{a}, R^{b}, R^{c}, and R^{d} are each independently selected from a C₁ to C₃₀, straight chain or branched alkyl group, a C₃ to C₈ cycloalkyl group, or a C₆ to C₁₀ aryl group, or any two of R^{b}, R^{c}, R^{d}, R^{e} and R^{f} attached to adjacent carbon atoms form a methylene chain —(CH₂)_{q}— wherein q is from 3 to 6; and wherein said alkyl, cycloalkyl or aryl groups or said methylene chain are unsubstituted or may be substituted by one to three groups selected from: C₁ to C₆ alkoxy, C₂ to C₁₂ alkoxyalkoxy, C₃ to C₈ cycloalkyl, C₆ to C₁₀ aryl, C₇ to C₁₀ alkaryl, C₇ to C₁₀ aralkyl, —CN, —OH, —SH, —NO₂, —CO₂R^{x}, —OC(O)R^{x}, —C(O)R^{x}, —C(S)R^{x}, —CS₂R^{x}, —SC(S)R^{x}, —S(O)(C₁ to C₆)alkyl, —S(O)O(C₁ to C₆)alkyl, —OS(O)(C₁ to C₆)alkyl, —S(C₁ to C₆)alkyl, —S—S(C₁ to C₆ alkyl), —NR^{x}C(O)NR^{y}R^{z}, —NR^{x}C(O)OR^{y}, —OC(O)NR^{y}R^{z}, —NR^{x}C(S)OR^{y}, —OC(S)NR^{y}R^{z}, —NR^{x}C(S)SR^{y}, —SC(S)NR^{y}R^{z}, —NR^{x}C(S)NR^{y}R^{z}, —C(O)NR^{y}R^{z}, —C(S)NR^{y}R^{z}, —NR^{y}R^{z}, or a heterocyclic group, wherein R^{x}, R^{y} and R^{z} are independently selected from hydrogen or C₁ to C₆ alkyl, and wherein one of R^{a}, R^{b}, R^{c}, and R^{d} may also be hydrogen.

9. A process according to claim 5, wherein [Cat⁺] comprises a basic cationic species having the formula:
[Cat⁺-(Z-Bas)ₙ]
wherein:
Cat⁺ is a cationic moiety;
Bas is a basic moiety;
Z is a covalent bond joining Cat⁺ and Bas, or 1, 2 or 3 aliphatic divalent linking groups each containing 1 to 10 carbon atoms and each optionally containing 1, 2 or 3 oxygen atoms;
n is an integer of from 1 to 3.

10. A process according to claim 9, wherein [Cat⁺-Z-Bas] is selected from: 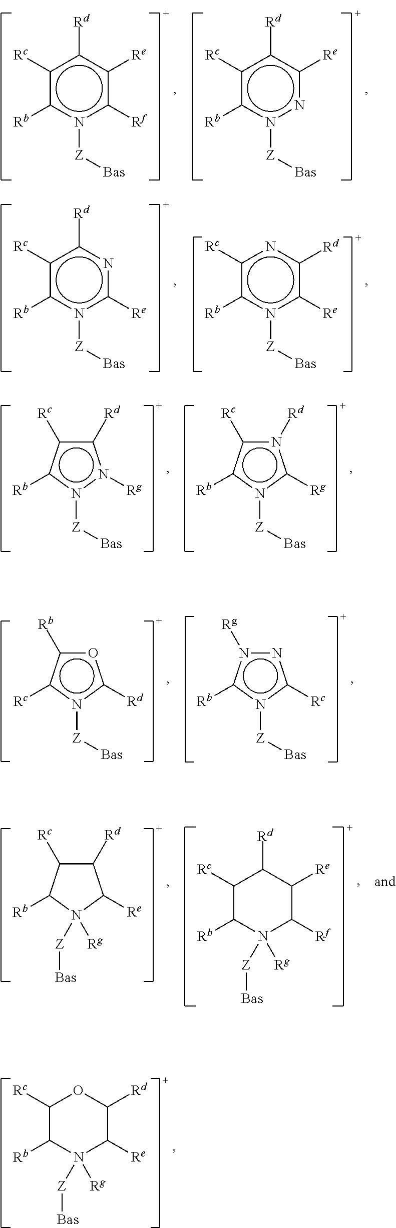
wherein:
R^{b}, R^{c}, R^{d}, R^{e}, R^{f}, R^{g} are as defined in claim 7; and
Bas and Z are as defined in claim 9.

11. A process according to claim 9, wherein [Cat⁺-Z-Bas] is selected from:
[N(Z-Bas)(R^{b})(R^{c})(R^{d})]⁺ and [P(Z-Bas)(R^{b})(R^{c})(R^{d})]⁺
wherein:
R^{b}, R^{c}, and R^{d} are as defined in claim 8; and
Bas and Z are as defined in claim 9.

12. A process according to claim 5, wherein [Cat⁺] comprises an acidic cationic species having the formula:
[Cat⁺-(Z-Acid)ₙ]
wherein:
Cat⁺ is a cationic species;
Acid is an acidic moiety;
Z is a covalent bond joining Cat⁺ and Bas, or 1, 2 or 3 aliphatic divalent linking groups each containing 1 to 10 carbon atoms and each optionally containing 1, 2 or 3 oxygen atoms; and
n is an integer of from 1 to 3.

13. A process according to claim 12, wherein [Cat⁺-Z-Acid] is selected from: 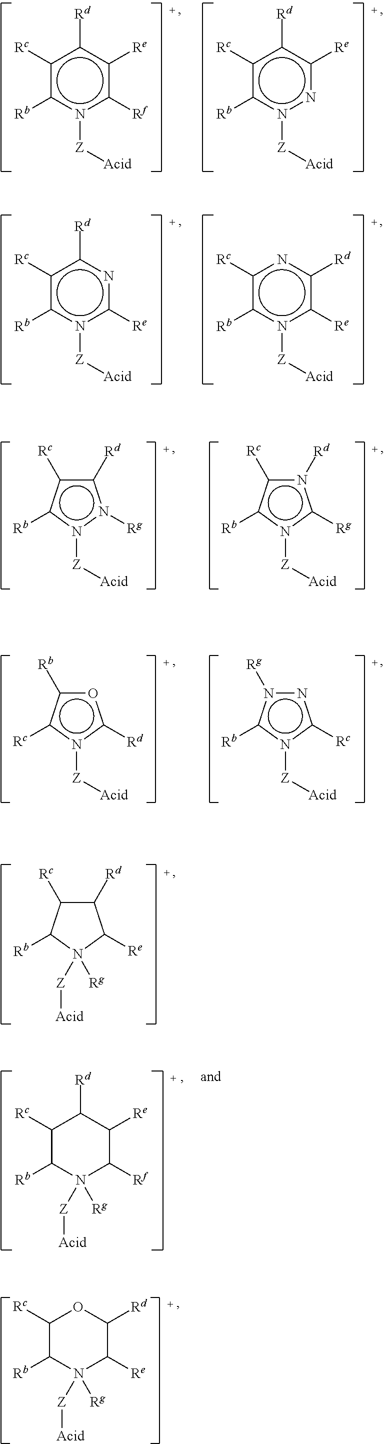
wherin:
R^{b}, R^{c}, R^{d}, R^{e}, R^{f} and R^{g} are defined as in claim 7;
Z and Acid are defined in claim 12.

14. A process according to claim 12, wherein [Cat⁺-Z-Acid] is selected from:
[N(Z-Acid)(R^{b})(R^{c})(R^{d})]⁺ and [P(Z-Acid)(R^{b})(R^{c})(R^{d})]⁺
wherein:
R^{b}, R^{c}, and R^{d} are as defined in claim 8;
Z and Acid are defined in claim 12.

15. A process according to claim 12, wherein Acid is selected from —SO₃H, —CO₂H, —PO(R)(OH)₂ and —PO(R)₂(OH); wherein each R is independently C₁ to C₆ alkyl.

16. A process according to claim 9, wherein Z is selected from linear or branched C₁ to C₁₈ alkanediyl, substituted alkanediyl, dialkanylether or dialkanylketone.

17. A process according to claim 5, wherein [X⁻] comprises an anionic species selected from: [F]⁻, [Cl]⁻, [Br]⁻, [I]⁻, [OH]⁻, [NCS]⁻, [NCSe]⁻, [NCO]⁻, [CN]⁻, [NO₃]⁻[NO₂]⁻, [(CN)₂N]⁻, [(CF₃)₂N]⁻, [BF₄]⁻, [PF₆]⁻, [SbF₆]⁻, [AsF₆]⁻, [R²₃PF₆]⁻, [HF₂]⁻, [HCl₂]⁻, [HBr₂]⁻, [HI₂]⁻, [HSO₄]⁻, [SO₄]²⁻, [R²OSO₃]⁻, [HSO₃]⁻, [SO₃]²⁻, [R²OSO₂]⁻, [R¹SO₂O]⁻, [(R¹SO₂)₂N]⁻, [H₂PO₄]⁻, [HPO₄]²⁻, [PO₄]³⁻, [R²OPO₃]²⁻, [(R²O)₂PO₂]⁻, [H₂PO₃]⁻, [HPO₃]²⁻, [R²OPO₂]²⁻, [(R²O)₂PO]⁻, [R¹PO₃]²⁻, [R¹₂PO₂]⁻, [R¹P(O)(OR²)O]⁻, [(R¹SO₂)₃C]⁻, [OR²]⁻, [bisoxalatoborate]⁻, [bismalonatoborate]⁻, [bis(1,2-benzenediolato)borate]⁻, [R²CO₂]⁻, [3,5-dinitro-1,2,4-triazolate], [4-nitro-1,2,3-triazolate], [2,4-dinitroimidazolate], [4,5-dinitroimidazolate], [4,5-dicyano-imidazolate], [4-nitroimidazolate], and [tetrazolate];
wherein: R¹ and R² are independently selected from the group consisting of C₁-C₁₀ alkyl, C₆ aryl, C₁-C₁₀ alkyl(C₆)aryl, and C₆ aryl(C₁-C₁₀)alkyl each of which may be substituted by one or more groups selected from: fluoro, chloro, bromo, iodo, C₁ to C₆ alkoxy, C₂ to C₁₂ alkoxyalkoxy, C₃ to C₈ cycloalkyl, C₆ to C₁₀ aryl, C₇ to C₁₀ alkaryl, C₇ to C₁₀ aralkyl, —CN, —OH, —SH, —NO₂, —CO₂R^{x}, —OC(O)R^{x}, —C(O)R^{x}, wherein each R^{x} is independently selected from hydrogen or C₁ to C₆ alkyl, and wherein R¹ may also be fluorine, chlorine, bromine or iodine.

18. A process according to claim 17, wherein [X⁻] comprises an anionic species selected from the group consisting of: [F]⁻, [Cl]⁻, [Br]⁻, [I]⁻, [EtSO₄]⁻, [CH₃SO₃]⁻, [(CF₃SO₂)₂N]⁻ and [CF₃SO₃]⁻.

19. A process according to claim 18, wherein [X⁻] comprises an anionic species selected from the group consisting of: [Cl]⁻, [Br]⁻, and [I]⁻.

20. A process according to claim 17, wherein [X⁻] comprises a basic anion selected from: [F]⁻, [Cl]⁻, [OH]⁻, [OR]⁻, [RCO₂]⁻, [PO₄]³⁻ and [SO₄]²⁻, wherein R is C₁ to C₆ alkyl.

21. A process according to claim 17, wherein [X⁻] comprises an acidic anion selected from: [HSO₄]⁻, [H₂PO₄]⁻, [HPO₄]²⁻, [HF₂]⁻, [HCl₂]⁻, [HBr₂]⁻ and [HI₂]⁻.

22. A process according to claim 1, wherein the ionic liquid is liquid at room temperature, where room temperature is defined as between 20° C. and 25° C.

23. A process according to claim 1, wherein at least one of the substrates comprises glass, resin, plastic, metal, ceramic, a semiconductor, glassy carbon, graphite, silica or alumina, and is provided with a surface layer comprising a transition metal, aluminium, thallium, tin, lead, or bismuth, or an alloy thereof, on at least a first surface of the substrate.

24. A process according to claim 23, wherein at least one of the substrates is a metal, and is provided with a surface layer comprising a transition metal, aluminium, thallium, tin, lead, or bismuth, or an alloy thereof, on at least a first surface of the substrate.

25. A process according to claim 24, wherein the at least one metal substrate is formed of a transition metal, aluminium, thallium, tin, lead, or bismuth, or an alloy thereof.

26. A process according to claim 1, wherein a first surface of at least one substrate comprises a transition metal, or an alloy thereof.

27. A process according to claim 26, wherein the transition metal is selected from iron, ruthenium, osmium, cobalt, rhodium, iridium, nickel, palladium, platinum, copper, silver and gold, or an alloy thereof.

28. A process according to claim 27, wherein the transition metal is selected from copper, silver and gold, or an alloy thereof.

29. A process according to claim 1, wherein the salt of the solder metal includes at least one member of a group consisting of: an indium halide and a gallium halide.

30. A process according to claim 29, wherein the salt of the solder metal includes at least one member of a group consisting of: indium(III) chloride and gallium(III) chloride.

31. A process according to claim 1, wherein the ionic liquid and the salt or salts of the solder metal are present in the electrodeposition mixture in a molar ratio of from 99:1 to 25:75.

32. A process according to claim 1, wherein the soldered joint is subsequently annealed by heating to a temperature of from 40° C. to 150° C. for a period of 1 minute to 24 hours.

33. An article manufactured using a soldering process as described in claim 1.

34. An article comprising a first substrate and at least one other substrate, wherein each substrate has a first surface comprising a group IB transition metal, aluminium, thallium, tin, lead, or bismuth, or an alloy thereof, and wherein the first surface of the first substrate is fused to the first surface of the at least one other substrate by an intermediate layer comprising at least one member of a group consisting of: indium and gallium.

35. (canceled)
